(19) United States
(12) Patent Application Publication
(10) Pub. No.: US 2011/0227255 A1
(43) Pub. Date: Sep. 22, 2011

(54) Manufacturing method for a shaped article having a very fine uneven surface structure

(75) Inventors: Hidehisa Murase, Kanagawa (JP); Yoshinari Sasaki, Tokyo (JP); Shunsuke Matsui, Kanagawa (JP); Kosei Aso, Kanagawa (JP)

(73) Assignee: Sony Corporation, Tokyo (JP)

(21) Appl. No.: 12/929,887

(22) Filed: Feb. 23, 2011

(30) Foreign Application Priority Data
Mar. 17, 2010 (JP) 2010-061391

(51) Int. Cl. B44C 1/22

(52) U.S. Cl. 264/400

(57) ABSTRACT

Disclosed herein is a manufacturing method for a molded article having a very fine uneven surface structure wherein, while a laser irradiation region is successively moved with respect to a working face of a working object article for each one shot, a laser beam is repetitively irradiated upon the working face of the working object article, the manufacturing method including the steps of: setting an energy density for the laser beam; setting a number of shots with which a desired fine shape is to be formed; calculating a speed of movement of the laser irradiation region with respect to the working face; and irradiating the laser beam of the set energy density while the working face is moved relative to the laser irradiation region at the calculated speed of movement to form a very fine uneven structure formed from working marks on the working face on which the fine shape is formed.

### BACKGROUND OF THE INVENTION

1. Field of the Invention

This invention relates to a decoration technique for use with an armor and a housing, for example, of home electrical appliances, and more particularly to a technique of applying a three-dimensional very fine surface working shape on an armor or housing using a laser beam so that the armor or housing having high decorability is provided.

2. Description of the Related Art

In recent years, the role of a decoration technique for differentiation of electric and electronic apparatus has become very significant. For example, in the field of portable telephone apparatus, portable terminal equipments formed using a cross cut technique so as to have a sparkling property for appealing to the visual sense, portable terminal equipments formed by drawing so as to have a touch like leather for appealing to the tactile sense and portable terminal equipments to which fine shapes are applied so as to prevent sticking of dirt or water drops thereto to appeal to the function are placed on the market. Further, in the field of notebook PCs, PCs of colorful models of a metallic tone are lined up by various makers, and attention is paid to original designs like owner-made designs.

What is significant here is to form a fine uneven structure on the surface of a molded article of a resin. A resin molded article having a fine uneven structure exhibits variation of a light transmission characteristic or a light reflection characteristic by its fine shape effect. Therefore, positively making use of this characteristic, a resin molded article is used in a wide range of industrial fields. In particular, a resin molded article is used as an optical functional film such as a diffusion plate or a light guide plate in the field of optics and as a plastic member having a metallic appearance of a deluster tone or a hairline tone in the field of various decoration structure members.

For example, if a method of applying a metallic tone appearance to the surface of a resin molded article is applied, then the resin molded article can be replaced with an existing article made of a metal material having a decoration performance without damaging a sense of high quality of the metal article. Simultaneously, such advantages as reduction in weight, reduction in cost and enhancement in degree of freedom in shape can be achieved. Therefore, the method described is very useful in the industry.

Several methods are available for applying a metallic tone appearance. In particular, as a method, a first method called molding simultaneous transferring method is known and disclosed, for example, in Japanese Patent Nos. 3,127,398 and 2,943,800 and Japanese Patent Laid-Open No. 2004-142439.

In the first method, a peelable sheet having a fine uneven structure on the surface thereof by evaporation or painting and having a metal layer or the like formed thereon is placed between molding metal molds and resin is injected and filled into the cavity of the molding metal molds to obtain a resin molded article while a transfer sheet is adhered simultaneously to the surface of the resin molded article, whereafter the mold releasing film is peeled to form a metal layer on the surface of the resin molded article.

As another method, a second method called insert method is known and disclosed, for example, in Japanese Patent Nos. 4,195,236, 3,851,523 and 3,986,789.

In the second method, an insert sheet formed from a base sheet having a fine uneven structure on the surface thereof and having a metal layer or the like formed thereon is inserted into a molding metal mold, and the insert sheet is integrated with the surface of a resin molded article simultaneously with injection molding.

As further methods, a third method wherein fine concaves and convexes are produced using a photo-setting material is known and disclosed in Japanese Patent Laid-Open No. 2007-237457, and a fourth method wherein a transfer material on which a plurality of colored layers are laminated is transferred to a resin molded article and an arbitrary one or ones of the colored layers are removed by laser etching is known and disclosed in Japanese Patent No. 4,054,569.

### SUMMARY OF THE INVENTION

However, the first to fourth methods described above are free from an idea to apply free curved face shapes as a fine uneven structure to provide a visual variation. For example, in the first method, the fine uneven structure is formed by an excavation method of physically applying scars. Meanwhile, in the second method, a printing method such as gravure printing, offset printing or screen printing is used. Further, in the third method, hairline working using a photo-setting resin material is used. Further, in the fourth method, multi-color molding wherein a colored layer is worked is used, but no fine uneven shape is formed.

In addition, the hairline working technique in related art uses sandblasting or sand matting. Therefore, the hairline working technique in related art provides non-uniform finish, and merely allows control of “average roughness” while it fails to control the shapes accurately to designed shapes.

The present invention proposes a technique which can apply a free curved face shape to the visual sense and can yield a novel visual effect by application of a laser fine working technique. The present invention proposes also a technique which provides a novel manner of looking to a visual sense in reflection or diffusion by positive application of working marks or shell marks unique to laser working while the marks are controlled.

According to the present invention there is provided a manufacturing method for a molded article having a very fine uneven surface structure wherein, while a laser irradiation region is successively moved with respect to a working face of a working object article for each one shot, a laser beam is repetitively irradiated upon the working face of the working object article. The manufacturing method includes the steps of setting an energy density for the laser beam for carrying out working of the working face of the working object article to a predetermined depth, setting a number of shots with which a desired fine shape is to be formed on the working face when the laser beam of the energy density is repetitively irradiated upon the working face, calculating a speed of movement of the laser irradiation region with respect to the working face for irradiating the laser light of the set shot number upon the working face, and irradiating the laser beam of the set energy density while the working face is moved relative to the laser irradiation region at the calculated speed of movement to form a very fine uneven structure formed from working marks by the laser light irradiation on the working face on which the fine shape is formed.

In the manufacturing method for a shaped article having a very fine uneven surface structure, by appropriately setting the energy density of the laser beam to be irradiated and the speed of movement of the laser irradiation region on the working face, free fine shapes can be formed freely. Further, very fine shapes can be formed on the surface of the fine shapes making use of working marks by the laser beam irradiation.

With the manufacturing method for a shaped article having a very fine uneven surface structure, by applying a laser fine working technique, free curved shapes can be applied to the visual sense and novel visual effects can be yielded. Further, by positively applying working marks or shell marks unique to laser working while the marks are controlled, a very fine uneven surface structure which provides a visual effect which has not been achieved in reflection or diffusion can be achieved.

The above and other features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIG. 1 is a block diagram showing an example of a configuration of a laser working apparatus to which a manufacturing method for a shaped article having a very fine uneven surface structure is applied;

FIG. 2 is a schematic view illustrating a working example of an OG method;

FIG. 3 is a schematic perspective view illustrating a relative position of a mask and a substrate as a working object article;

FIG. 4 is a schematic view showing an example of a mask used in the manufacturing method for a shaped article having a very fine uneven surface structure;

FIG. 5 is a diagrammatic view illustrating a curved line of a multi-dimensional polynomial for forming a three-dimensional shape;

FIG. 6 is a schematic view illustrating an etching sectional area for obtaining a desired convex shape;

FIG. 7 is a schematic view illustrating a mask shape for obtaining the desired convex shape;

FIG. 8 is a diagrammatic view illustrating an etching sectional area for obtaining a desired concave shape;

FIG. 9 is a schematic view illustrating a mask shape for obtaining the desired concave shape;

FIG. 10 is a diagram illustrating a relationship between the irradiation energy of a laser beam and the etching depth;

FIG. 11 is a diagram illustrating a relationship between the table feeding speed and the etching depth;

FIGS. 12A and 12B are schematic views illustrating an aspect ratio of a mask;

FIG. 13 is a schematic view showing an example of a mask;

FIG. 14 is a schematic view illustrating superposition using the mask shown in FIG. 13;

FIGS. 15A and 15B are a schematic view and a diagrammatic view, respectively, illustrating a mask having a linear line or triangular shape according to a first working mode;

FIG. 16 is a perspective view showing a working shape obtained using the mask shown in FIG. 15A;

FIG. 17 is a perspective view showing a fine uneven surface structure obtained using the mask shown in FIG. 15;

FIG. 18 is a schematic view showing an example of a product which uses a molded article having the fine uneven surface structure shown in FIG. 17;

FIGS. 19A and 19B are a schematic view and a diagrammatic view, respectively, illustrating a mask having an elliptic edge according to a second working mode;

FIG. 20 is a perspective view showing a working shape obtained using the mask shown in FIG. 19A;

FIG. 21 is a schematic view illustrating a rearward reflection effect of a fine uneven surface structure formed from a convex working shape shown in FIG. 20;

FIGS. 22A and 22B are diagrammatic views illustrating superposition irradiation in the same scanning direction upon a mask having an elliptic arc and another mask having a linear line according to a third working mode;

FIG. 23 is a perspective view showing a working shape obtained by superposition irradiation in the same scanning direction upon a mask having a linear line and another mask having an elliptic arc;

FIG. 24 is a perspective view showing a fine uneven surface structure obtained by superposition irradiation in the same scanning direction upon a mask having a linear line and another mask having an elliptic arc;

FIG. 25 is a perspective view showing a fine uneven surface structure obtained by superposition irradiation in perpendicular scanning directions upon a mask having a linear line and another mask having an elliptic arc according to a fourth working mode;

FIG. 26 is a flow chart illustrating a manufacturing method for a molded article having the fine uneven surface structure shown in FIG. 25;

FIGS. 27A to 27G are schematic perspective views illustrating a manufacturing method for a molded article having the fine uneven surface structure shown in FIG. 25;

FIGS. 28 and 29 are schematic perspective views showing different examples of working marks or shell marks in the case where an excimer laser is used;

FIG. 30 is a perspective view showing working marks in the case where a solid-state laser is used;

FIGS. 31A and 31B are schematic views illustrating formation of very fine shapes utilizing working marks;

FIG. 32 is a schematic view illustrating formation of working masks using a solid-state laser;

FIG. 33 is a diagrammatic view illustrating an example of measurement of a cross sectional shape of working marks in the case where a structure color effect is obtained strongly;

FIG. 34 is a similar view but illustrating an example of measurement of a cross sectional shape of working marks in the case where the structure color effect is poor;

FIGS. 35A to 35C are schematic views illustrating working marks formed in the case where a mask having a triangular opening is used;

FIGS. 36A to 36C are schematic views illustrating working marks formed in the case where a mask having an opening including a concave curved face is used;

FIGS. 37A to 37C are schematic views illustrating working marks formed in the case where a mask having an opening including a convex curved face is used;

FIGS. 38A to 38C are schematic views illustrating working marks formed in the case where a mask having a circular opening is used;

FIG. 39 is a schematic view showing a particular example of circular working marks;

FIG. 40 is a schematic view showing a particular example of linear working marks;

FIG. 41 is a schematic view illustrating a measuring method of visual evaluation data;

FIG. 42 is a view illustrating result of visual evaluation;

FIG. 43 is a view illustrating a summary of the visual evaluation;

FIG. 44 is a schematic view showing a fine structure of the surface of a wing of a butterfly;

FIGS. 45A and 45B are schematic views illustrating a visual effect depending upon presence/absence of curved line shapes;

FIGS. 46A and 46B are schematic views illustrating a visual effect depending upon presence/absence of working marks;

FIG. 47 is a diagram illustrating a reflection intensity distribution with regard to perpendicular visible rays;

FIG. 48 is a similar view to FIG. 47 but illustrating a reflection intensity distribution with regard to visible rays when a molded article is tilted by 5 degrees;

FIGS. 49A to 49C are schematic views showing an example of a product which includes a molded article having a very fine uneven surface structure; and

FIG. 50 is a schematic exploded perspective view showing another example of a product which includes a molded article having a very fine uneven surface structure.

### DETAILED DESCRIPTION OF THE PREFERRED EMBODIMENTS

In the following, embodiments of the present invention are described with reference to the accompanying drawings. The description is given in the following order.

1. Laser working apparatus and OG method

2. First working mode (example wherein a mask having a linear line (triangle) is used)

3. Second working mode (example wherein a mask having an elliptic arc is used)

4. Third working mode (example wherein a mask having a linear line (triangle) and another mask having an elliptic arc are placed one on the other in the same scanning direction is used)

5. Fourth working mode (example wherein a mask having a linear line (triangle) and another mask having an elliptic arc are placed one on the other in perpendicular scanning directions is used)

6. Very fine uneven structure

7. Visual effect

8. Product examples (product examples wherein a molded article having a very fine uneven structure on the surface thereof is applied)

It is to be noted that embodiments described below are preferred modes in embodying the present invention. Therefore, various technically preferable restrictions are applied to the embodiments. However, unless it is specifically described in the following description that the present invention is restricted, the technical scope of the present invention is not restricted to the embodiments hereinafter described. For example, particulars specified in the following description regarding a used material and a used amount of the material, processing time, a processing order, numerical value condition of parameters and so forth are mere examples which are considered preferable, and also dimensions, shapes, relationships in arrangement and so forth appearing in the drawings referred to in the following description are shown for illustrative purposes.

### <1. Laser Machining Apparatus and OG Method>

### Configuration of Laser Working Apparatus

In a manufacturing method for a molded article having a very fine uneven surface structure according to the present embodiment, light energy is utilized to form a desired three-dimensional shape on a working object article. Further, while a three-dimensional shape is formed, a working mark, that is, a shell mark, unique to laser working is controlled to form very fine uneven shapes on the surface of a working face. A laser working apparatus used in embodiments of the present invention includes a laser light source having a wavelength in the ultraviolet wavelength region which is liable to be absorbed by a resin, and an optical system for optically projecting a laser beam emitted from the laser light source in a predetermined pattern on a working face of a working object article, that is, a substrate.

A laser beam having a wavelength in the ultraviolet wavelength region is liable to be absorbed by a resin material such as, for example, polyimide. As a result, etching can be carried out for such a resin material as just mentioned by a method called ablation which cuts binding between molecules by high photon energy. In ablation working, since the amount of heat generation is small, thermal sagging, dross or protuberance or the like does not occur, and a mask pattern can be transferred accurately to a working face. Therefore, the ablation working is very advantageous for working of fine shapes. Further, since working of fine shapes in the etching depthwise direction can be controlled by an integrated value of energy of the laser beam per unit time, a free curved face can be produced.

A basic configuration of a laser working apparatus commonly used in several embodiments of the present invention is described below with reference to the accompanying drawings.

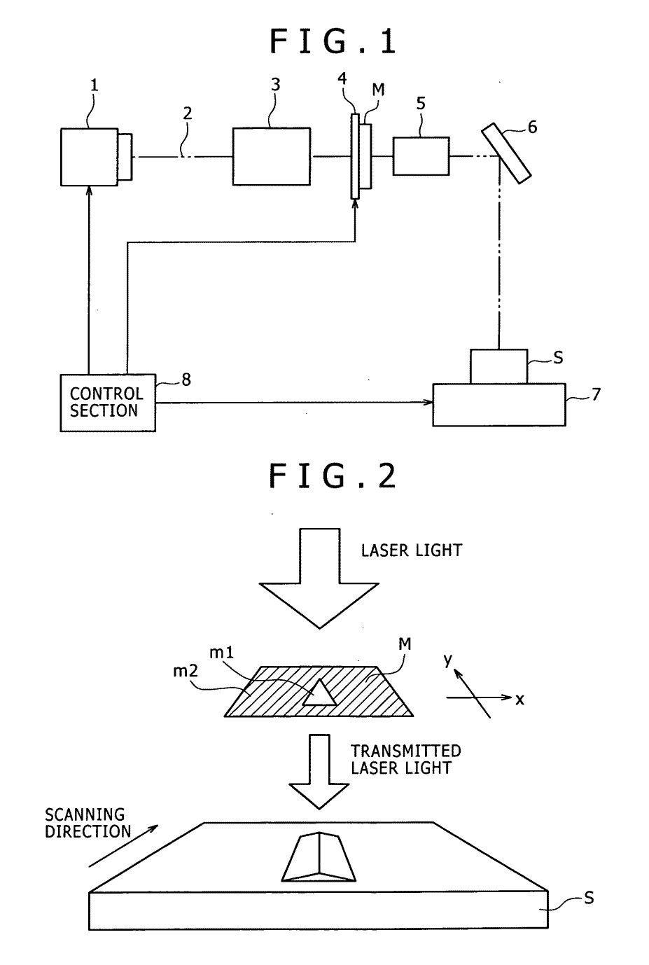

FIG. 1 shows an example of a general configuration of a laser working apparatus for manufacturing a molded part having a very fine uneven surface structure. Referring to FIG. 1, the laser working apparatus shown includes a laser light source 1, a beam shaping unit 3, a mask stage 4, a mask M, a reducing projection lens 5, a mirror 6, and a stage 7. A laser light path is indicated by an alternate long and two short dashes line denoted by reference numeral 2.

The laser light source 1 emits a beam of a laser light strength in accordance with a control signal from a control section 8. In the embodiment described below, for example, an excimer laser is used. A plurality of types of excimer lasers are available and are formed using different media such as, if listed in a descending order of the wavelength, XeF (351 nm), XeCl (308 nm), KrF (248 nm), ArF (193 nm) and F₂ (157 nm). Such excimer lasers irradiate pulses of 200 to 500 Hz.

However, the laser is not limited to such excimer lasers but may be a laser which includes second to fourth harmonics of a solid state laser or a like laser. A solid state laser irradiates a beam in the form of pulses of several tens kHz and carries out fine working while scanning like a picture drawn with a single stroke. The beam shaping unit 3 carries out shaping of a laser beam from the laser light source 1 and uniformization of the beam strength and outputs a resulting beam.

The mask M has openings of a predetermined pattern to which places at which the laser light is transmitted and not transmitted are set in accordance with a working shape and which transmits therethrough the laser beam shaped by the beam shaping unit 3. For this mask M, for example, a perforated mask formed from a metal material, a photomask formed from a transparent glass material or metal thin film, a dielectric mask formed from a dielectric material and so forth are used. Also it is possible to apply a variable aperture in place of the mask M. The mask stage 4 includes a mechanism which receives the mask M placed thereon and can be positioned along a plane perpendicular to the optical axis of the laser beam in accordance with a control signal from the control section 8.

The reducing projection lens 5 collects a laser beam transmitted through the pattern of the mask M and projects the collected laser beam at a predetermined magnification upon a working face of a substrate S which is a working object article on the stage 7. The stage 7 is disposed with respect to the reducing projection lens 5 such that the laser beam projected from the reducing projection lens 5 is focused on the working face of the substrate S.

This stage 7 includes a mechanism which holds the substrate S of a working object article by vacuum suction or the like and can be moved along and positioned on a plane, that is, an XY plane, perpendicular to the optical axis of the laser beam in accordance with a control signal from the control section 8 such that the laser beam can be scanned on the working face of the substrate S. In addition, the stage 7 can be moved along the height direction (Z direction) from the substrate S as required.

In this laser working apparatus, while an excimer laser beam is irradiated on the surface of the substrate S through the mask M having an opening of a predetermined shape, the stage 7 is moved so that an irradiation region of the excimer laser beam is scanned, that is, the irradiation region of the laser beam is moved, on the working face to carry out substrate working based on the opening shape of the mask M. Such working is based on a working principle described below. Working principle of OG method

FIG. 2 illustrates a working principle of the OG method, that is, orthogonal method. In particular, according to the OG method, while a laser beam is irradiated upon the substrate S of a working object article through the mask M having a desired opening, the irradiation region is scanned to obtain a three-dimensional shape on the substrate S.

In the mask M, an opening m1 of a predetermined shape though which a laser beam is transmitted and a light blocking portion m2 through which a laser beam is not transmitted are provided. Here, the opening m1 of the mask M is a portion through which light is transmitted and may be in the form of an opening hole or a light transmitting or transparent window. If a laser beam is irradiated through the mask M, then the laser beam having a shape corresponding to the shape of the opening m1 of the mask M is irradiated upon the substrate S.

If the laser beam of a shape corresponding to the shape of the opening m1 is irradiated upon the substrate S, then a photo-chemical reaction called ablation is caused by photon energy by the laser beam. Consequently, the substrate S can be worked while suppressing a thermal influence.

The working shape depends upon an integrated value of the irradiation amount of the laser light transmitted through the opening m1 of the mask M, and the working depth by the laser light depends upon the integrated value. In particular, as the opening area of the mask M decreases, the irradiation amount decreases and consequently the working depth decreases.

Here, if the irradiation region of the laser light irradiated through the mask M is scanned on the substrate

S, then the irradiation amount becomes an integrated value along the scanning direction. In other words, in the case where, with regard to the shape of the opening m1 of the mask M, the direction perpendicular to the scanning direction is the direction of the x axis and the scanning direction is the direction of the y axis, the working depth differs depending upon the length of the opening m1 along the y axis direction.

In particular, as the length of the opening m1 along the y axis direction decreases, the integrated value of the irradiation amount along the scanning direction decreases and the working depth decreases. On the other hand, as the length of the opening m1 along the y axis direction increases, the integrated value of the irradiation amount along the scanning direction increases and the working depth increases. By scanning the irradiation region, the shape of the cross section of the working depth continues in the scanning direction, and a three-dimensional shape extending in the scanning direction is formed.

For example, where a mask M having an opening m1 of a triangular shape whose apex is disposed along the scanning direction as seen in FIG. 2, a portion of the substrate S corresponding to an apex of the triangle is formed deepest, and a concave shape of a cross section of a triangular shape along the x axis is formed continuously in the scanning direction, that is, in the y axis direction.

In the case where the energy of the laser light emitted from the laser light source 1 is fixed, the working depth by irradiation of the laser light has a relationship also to the scanning speed of the irradiation region. In particular, as the scanning speed decreases, the irradiation amount per unit time and per unit area increases and the working depth increases. Therefore, the three-dimensional shape formed on the substrate S can be controlled with the setting of the shape of the opening m1 of the mask M and the scanning speed of the irradiation region.

Working Method using OG Method

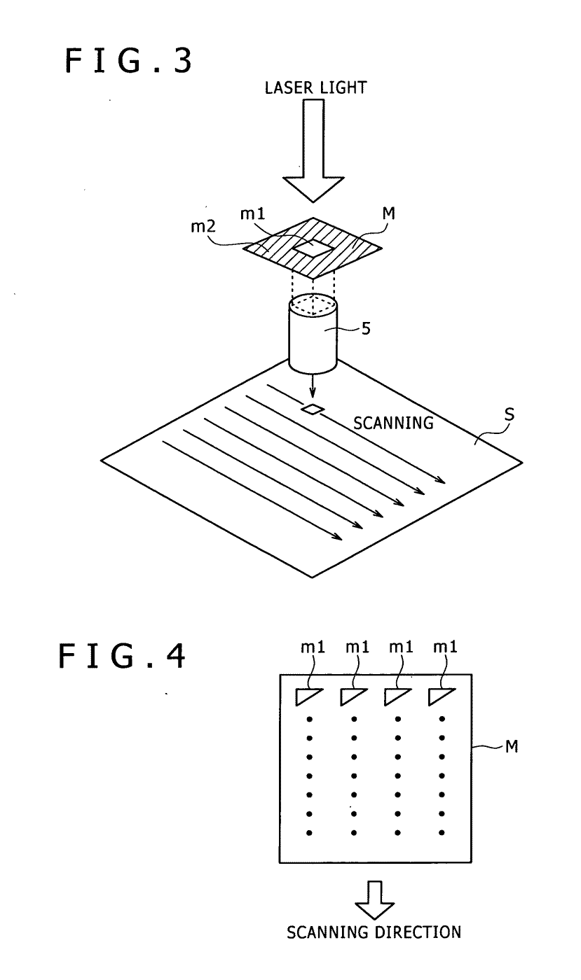

FIG. 3 illustrates a relative position of a mask and a substrate as a working object article. Referring to FIG. 3, an opening m1 of a predetermined shape is provided in a mask M such that laser light is sent to a reducing projection lens 5 through the mask M.

The reducing projection lens 5 reduces the magnitude of the irradiation region corresponding to the shape of the opening m1 of the mask M, for example, to a fraction to make it possible to achieve a high energy density through concentration of the irradiation energy.

In a state in which laser light is irradiated, the substrate S or the mask M or else both of the substrate S and the mask M are relatively moved in the direction opposite to the scanning direction. Consequently, the irradiation region of the laser light is scanned in the predetermined direction and continuous working is carried out along the scanning direction.

Further, if scanning for one stage is completed, then the irradiation region is shifted by one stage distance in a direction perpendicular to the scanning direction, and then irradiation and scanning of the laser light are carried out similarly. By carrying out the sequence of operations repetitively, working over a wide range of the substrate is carried out. If scanning of the irradiation region of the laser light along one direction is carried out by a plurality of stages as seen in FIG. 3, then three-dimensional shapes continuous in the scanning direction can be formed.

Further, after three-dimensional shapes continuous in the scanning direction is formed, if the scanning direction of the laser light is changed to a perpendicular direction to the former scanning direction and then similar scanning is carried out, then working in the two perpendicular directions is carried out in an overlapping relationship and a lattice-type three-dimensional shape can be formed. In particular, the irradiation region of the laser light through the mask M is scanned in one direction and, after working of the substrate S along the scanning direction is carried out, the scanning direction is changed to a direction perpendicular to the former scanning direction to carry out laser light irradiation on the substrate S after worked. By this, the shape worked by scanning in the one direction is further worked in the perpendicular direction, and consequently, a lattice-type three-dimensional shape can be obtained.

For example, in the case where a three-dimensional shape having a cross section of a semicircular shape extending along the scanning direction of the laser light is formed, if this working is carried out in the two perpendicular directions, then a plurality of semispherical shapes such as, for example, lens shapes arrayed in a lattice pattern can be obtained. The working in the two perpendicular directions is hereinafter described in detail.

It is to be noted that, in the scanning of the laser light in the two directions, the angle between the two scanning directions may be set to some other angle than the right angle. In the case where the angle between the two scanning directions is made different from the right angle, three-dimensional shapes having an aspect ratio can be formed in a lattice pattern. Further, the number of scanning directions is not limited to two but may be three or four. Where scanning in three directions is used, for example, the substrate S is successively rotated so that the scanning direction is successively changed by 120 degrees. It is to be noted that, if such scanning in three directions is carried out in the conditions described above, the working shape of a portion formed by scanning in the three directions in the case where the working face is viewed from above is a hexagon. Various other scanning methods are available such as scanning in circumferential directions by different diameters, spiral scanning, a combination of scanning in a circumferential direction and scanning in a radial direction from the center of the circumference and so forth.

### Configuration of Mask

FIG. 4 shows an example of a mask used in the manufacturing method of a molded article having a very fine uneven surface structure according to the present embodiment. Referring to FIG. 4, the mask M shown includes an opening formation region in which a plurality of openings m1 are juxtaposed in a matrix. The widthwise direction of the mask M is the horizontal direction in FIG. 4, and the scanning direction or moving direction of the irradiation region of a laser beam through the mask M is the vertical direction in FIG. 4. In the opening formation region of the mask M, a row of a plurality of openings m1 is provided along the widthwise direction of the mask M. Further, a plurality of such rows of plural openings m1 are provided in a direction perpendicular to the widthwise direction of the mask M. In FIG. 4, the openings m1 are disposed in four columns in the scanning direction such that each column includes several openings m1. However, the number of openings is designed suitably. For example, in the case where an opening of an approximately 22 mm square is formed in a mask of a 150 cm (approximately 5-inch) square, 5×5=25 openings can be formed. The size of the openings m1 is finally determined in accordance with a desired very fine uneven shape for the working face, the reduction rate of the reducing projection lens 5 and so forth.

### Basic Concept of Mask

In order to obtain a desired working shape by the OG method using this mask, several parameters are used such as the irradiation energy of a laser beam, the feeding speed of the substrate, the opening rate of the mask and so forth, and a mask conforming to an individual working shape can be designed by suitably setting the parameters.

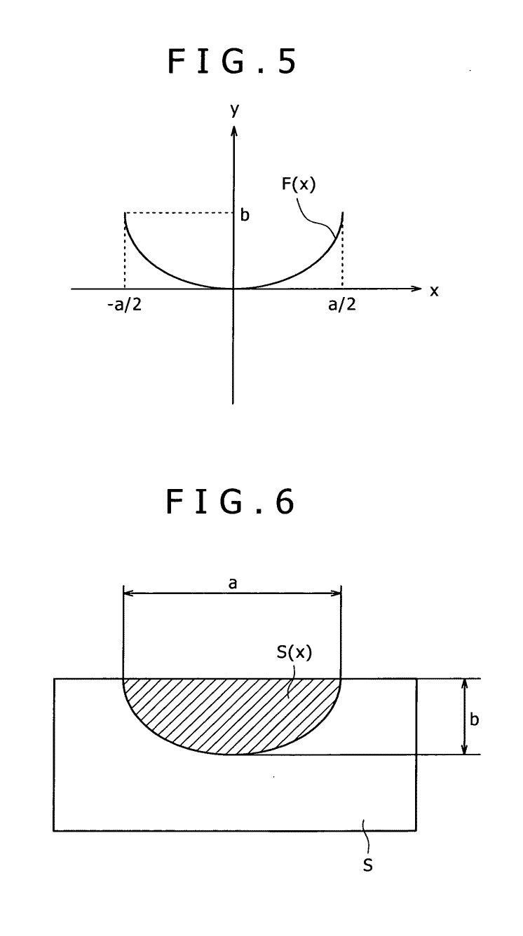

FIG. 5 is a graph showing a certain curve, which is represented by a function F(x). Here, a mask for obtaining a concave working shape on which the curve shown in FIG. 5 and represented by the function F(x) is reflected is studied. In the working shape of a working face, the working depth by a laser beam is determined by an integrated value according to a shape of an edge of an opening of a mask through which a laser beam is transmitted. Therefore, in order to obtain a desired concave shape on the substrate S shown in FIG. 6, the sectional area S(x) to be etched from the surface of the substrate S is represented, as seen from a portion indicated by slanting lines in FIG. 6, by the following expression:

S(x)=ab−∫F(x)dx.

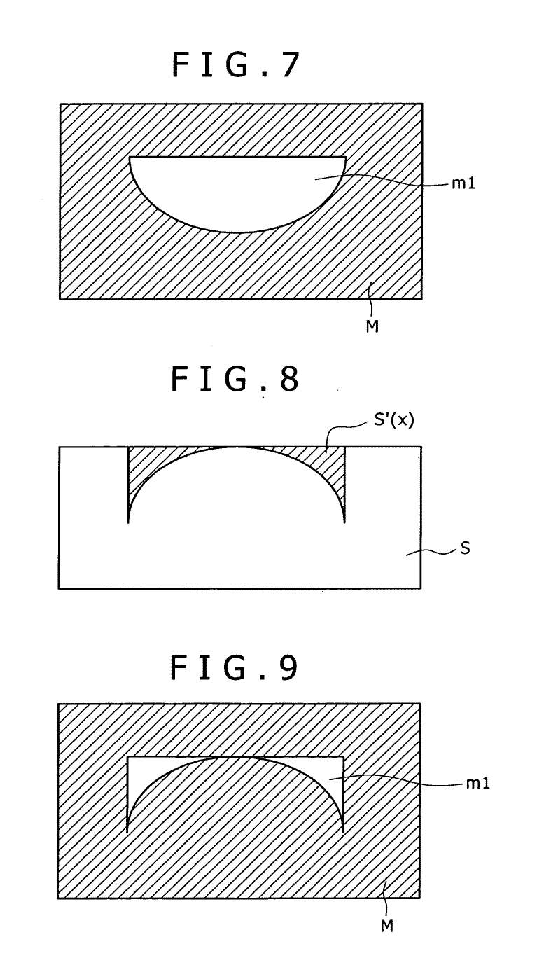

In order to obtain this working shape, such a mask M of an opening m1 of a substantially semicircular shape including the function F(x) of FIG. 5 as shown in FIG. 7 may be used.

It is to be noted that a schematic view illustrating an etching sectional area S′(x) of a substrate for obtaining a convex shape is shown as an example in FIG. 8. A schematic view illustrating a mask shape for obtaining this convex shape is shown in FIG. 9.

Now, a relationship of the irradiation energy of a laser beam and the feeding speed of a table with the etching depth is described.

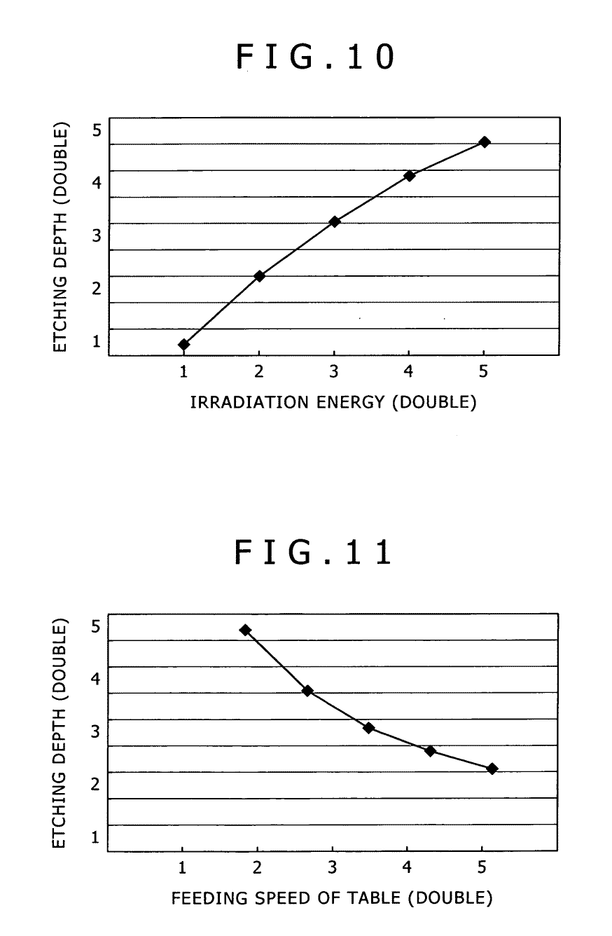

FIG. 10 illustrates a relationship between the irradiation energy of a laser beam and the etching depth, and the axis of abscissa indicates the irradiation energy of laser light and the axis of ordinate indicates the etching depth. Meanwhile, FIG. 11 illustrates a relationship between the feeding speed of the table for a substrate and the etching depth, and the axis of abscissa indicates the feeding speed of the table and the axis of ordinate indicates the etching depth. From FIGS. 10 and 11, it can be recognized that the etching depth increases as the irradiation energy of a laser beam increases and the etching depth decreases as the feeding speed of the table for a substrate increases.

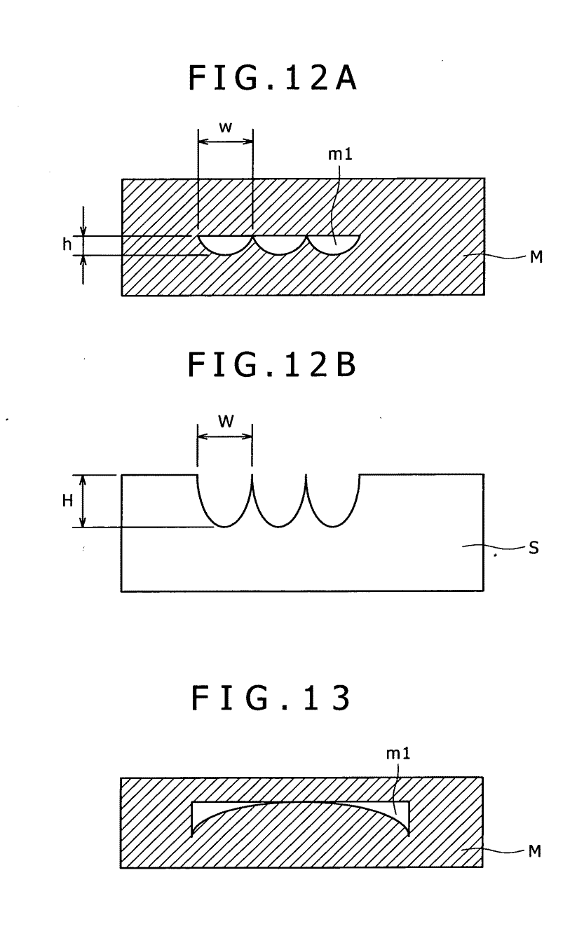

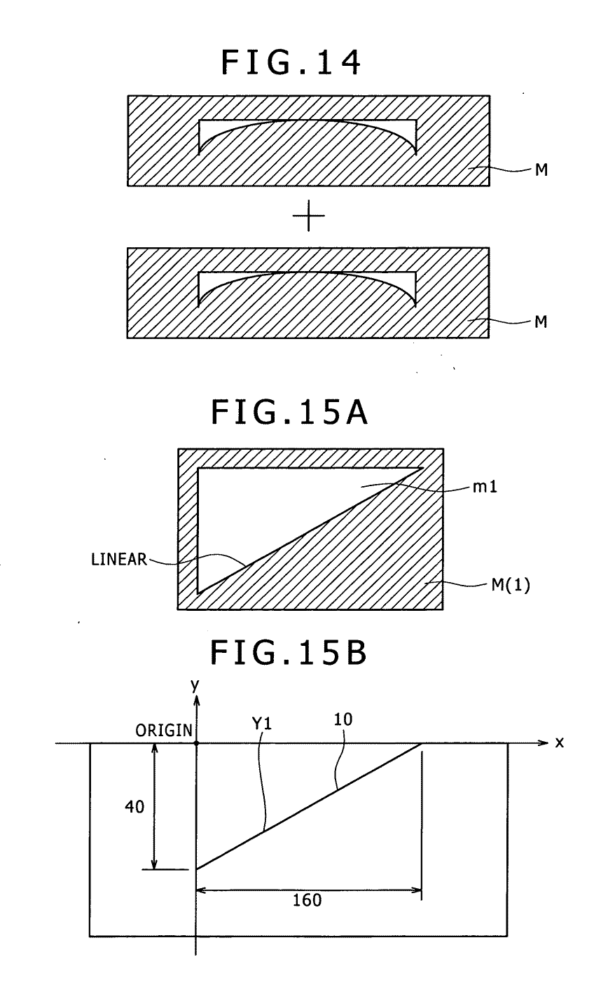

FIGS. 12A and 12B are schematic views showing sectional views of a mask and a working shape obtained using the mask, respectively. It is assumed that the aspect ratio h/w of one opening m1 of the mask M shown in FIG. 12A and the aspect ratio H/W of an actually obtained worked article shown in FIG. 12B are increased to a times. The relationship between them in this instance is represented by the following expression:

a=(h/w)/(H/W).

The coefficient a given above varies depending upon the irradiation energy of the laser beam and the feeding speed of the table for a substrate. Therefore, the coefficient a corresponding to the function f(x) of the mask is obtained in advance from an experiment.

### Superposition of Laser Beam

Now, superposition of a laser beam is described.

As an example, an example in the case where part of such a working shape as shown in FIG. 8 is worked into a convex shape having a curved face of a function represented by F(x)=−X² is described. In this instance, the sectional area S′(x) of an amount laser-worked or etched from the substrate surface using the mask M shown in FIG. 9 is such as a portion indicated by slanting lines in FIG. 8. This sectional area S′(x) is represented by the following expression:

S′(x)=∫X²dx

In order to obtain this working shape, a mask M having a curved face corresponding to a function f(x)=−1/2X² illustrated in FIG. 13 may be used such that irradiation is carried out twice in an overlapping relationship on the same irradiation region using the same mask M. By this operation, a convex working shape represented by F(x)=−X² can be obtained. In particular, if a laser beam is irradiated twice in an overlapping relationship using a mask represented by the function f(x) as seen in FIG. 13, then this can be represented in the following manner:

F(x)=f(x)+f(x), which means

F(x)=−1/2X²−1/2X².

This represents that the working shape represented by the function of F(x)=−X² can be implemented by irradiating a laser beam twice in an overlapping relationship using the mask of f(x)=−1/2X².

Similarly, in order to work a convex shape corresponding to a profile of, for example, F(x)=−2X², irradiation of a laser beam is carried out four times in an overlapping relationship using a mask corresponding to the function f(x)=−1/2X².

In particular, in order to obtain a working shape corresponding to a desired function, masks having openings represented by individual functions are used such that laser light is irradiated through the masks placed in a superposed relationship at the same position. Since the working shape depends upon the integrated value by an opening through which laser light is irradiated, a working shape corresponding to a desired function in the form of a multi-dimensional polynomial can be obtained.

### <2. First Working Mode>

A first working mode is an example wherein a mask having a linear line on an edge of an opening m1 as shown in FIGS. 15A and 15B is used to apply a planar fine shape on the substrate surface.

First, a mask M(1) having a linear line on an edge of an opening m1 as shown in FIG. 15A is used to set certain light energy and a feeding speed of an substrate S of a working object article, and a working shape obtained in accordance with the conditions is measured in advance.

FIG. 15B shows a graph obtained by mathematically approximating a profile obtained from a shape actually obtained by working using the mask M(1). Here, the XY axes are set with reference to the origin at a left end in FIG. 15B of the working portion on the substrate surface to be worked. The particular working shape in this instance exhibits an inverted triangular shape as viewed in cross section, and the depth, that is, the etching amount, is 40 and the width is 160. It is to be noted that the unit of the numerical values is μm. The approximation expression Y1 obtained from this graph is represented by the following expression:

Y1=X/4−40. (6)

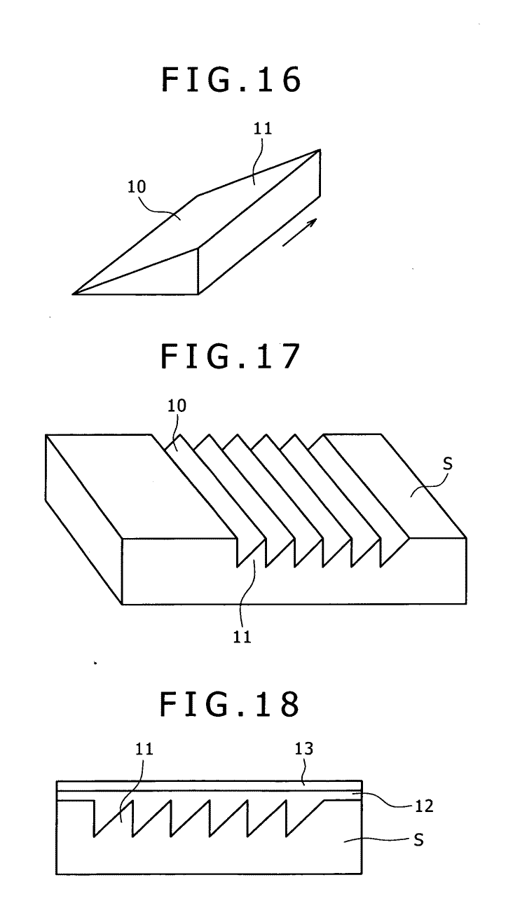

By moving the stage 7 in the scanning direction while the opening shape of the mask M formed in such a triangular shape as described above is transferred, a two-dimensional energy distribution corresponding to the opening shape of the triangle is time-integrated so as to be converted into an etching amount in the depthwise direction. Then, the working shape of a cross section along the XY plane obtained in accordance with an approximation expression Y1 is such a triangular working shape 11 as shown in FIG. 16. The triangular working shape 11 is such a shape that a triangular pole having a bottom face of a generally triangular shape having a base of 160 μm wide and a height of 40 μm is disposed such that the heightwise direction thereof coincides with the scanning direction indicated by an arrow mark in FIG. 16. The gradient of the approximation expression Y1 corresponds to the gradient of a slanting face 10 of the triangular working shape 11.

FIG. 17 shows a three-dimensional shape shaped using the mask of FIG. 15A. In the shaped article shown in FIG. 17, a plurality of triangular poles each having the triangular working shape 11 as a cross sectional shape thereof are formed in a juxtaposed relationship in a direction perpendicular to the scanning direction, that is, in the x axis direction. The shaped article thus has a serrate fine shape having a plurality of mountains having a peak of an acute angle. While, in the example shown in FIG. 17, one mountain has a shape of a triangular pole, it may have any shape only if a reflecting face, that is, the slanting face 10, is a flat face.

FIG. 18 shows a product as a housing for which a shaped article having the very fine uneven surface structure shown in FIG. 17 is used. Referring to FIG. 18, in the example shown, a color layer 12 is formed on a working face of a substrate S having the very fine uneven surface structure of the triangular working shape 11, and a protective layer 13 is formed on the color layer 12.

With the shaped article having the fine shape of the serrate triangular working shape 11, an increase of the angular field of view by approximately 40 degrees from that of another article which has no such fine shape is observed. Meanwhile, since the reflecting face, that is, the slanting face 10, has a flat face shape, when a critical angle is exceeded, no reflection occurs at all and no visual change is found. Visual evaluation is hereinafter described in detail together with other fine working shapes.

It is to be noted that, while the substrate S in the present embodiment is formed using a polycarbonate material, high quality working can be achieved using any other material which absorbs laser light of a laser wavelength such as an acrylic material, a polyethylene material and a polyimide material including a metal material. Further, in place of direct working of a fine shape, a method may possibly be used wherein a metal mold is fabricated using a shaped part as an original to transfer the shape or a film is produced and pasted. Since an original having a fine shape is obtained, the mass productivity is improved in comparison with that by film lamination or printing, resulting in suppression of the production cost. Further, while the present example assumes that the very fine uneven surface structure is watched through the color layer 12, alternatively a transparent material may be used for the substrate S such that the very fine uneven surface structure is watched through the transparent substrate S from the remote side from the color layer 12. In this instance, since the protective layer 13 does not appear on the surface of the product, it may be omitted.

### <3. Second Working Mode>

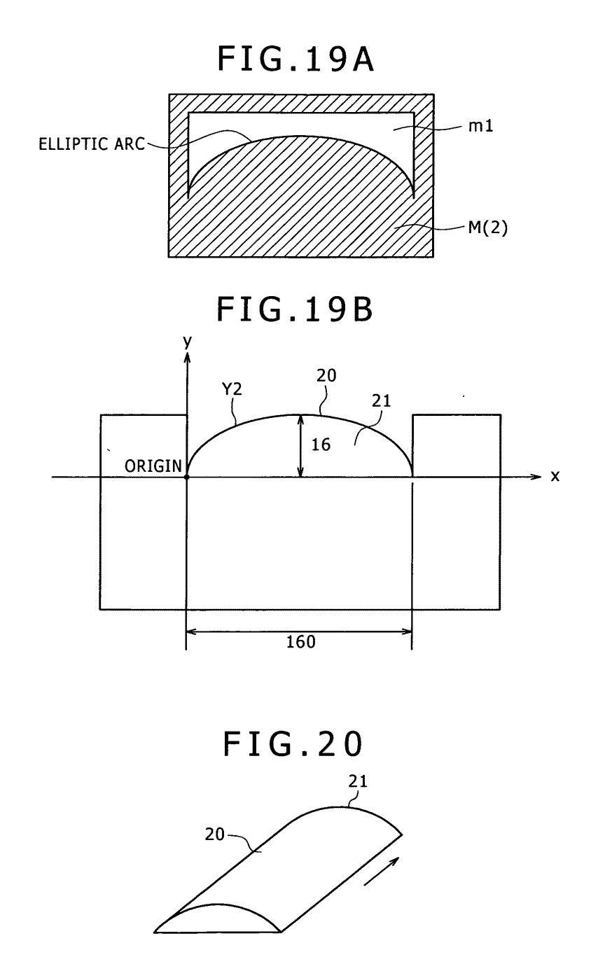

A second working mode is an example wherein a mask having an elliptic arc on an edge of an opening m1 shown in FIGS. 19A and 19B is used to apply a fine shape like a curved face to the substrate surface.

First, a mask M(2) having an elliptic arc on an edge of an opening m1 as shown in FIG. 19A is used to set certain light energy and a feeding speed of a substrate S of a working object article, and a working shape obtained as a result of the setting is measured in advance.

FIG. 19B shows a graph obtained by mathematically approximating a profile obtained from a shape actually obtained by working using the mask M(2). Here, the XY axes are set with reference to the origin at a left end in FIG. 19B of a bottom portion of a convex working shape. In the particular working shape in this instance, the height of the convex portion in cross section is 16, and the width of the bottom portion is 160. It is to be noted that the unit of the numerical values is μm.

From this graph, when 0<X<80,

{(X−80)²/80²}+{(Y2+16)²/16²}=1 (1)

is obtained as an approximation expression of the ellipsis.

On the other hand, when 80<X<160,

{(X−80)²/80²}+{(Y2+32)²/32²}=1 (2)

is obtained as an approximation expression of the ellipsis.

By moving the stage 7 in the scanning direction while the opening shape of the mask M formed in an elliptic arc is transferred, a two-dimensional energy distribution corresponding to the opening shape including the elliptic arc is time-integrated so as to be converted into an etching amount in the depthwise direction. Then, the working shape of a cross section along the XY plane obtained in accordance with the approximation expression Y2 is such a convex working shape 21 as shown in FIG. 20. The convex working shape 21 is such a shape that a cylinder having a bottom face of a generally elliptic shape having a base (linear portion) of 160 μm wide and a height of 16 μm is disposed such that the heightwise direction thereof coincides with the scanning direction indicated by an arrow mark in FIG. 20. The elliptic arc of the approximation expression Y2 corresponds to a curved face 20 of the convex working shape 21.

In the case of the convex working shape 21, a plurality of semi-cylinders having a cross sectional shape of the convex working shape 21 are formed in a juxtaposed relationship in a direction perpendicular to the scanning direction, that is, in the x axis direction such that they have a fine shape having a plurality of mountains each having a curved face at a top portion thereof. In short, such a shaped article that the top portions of the triangular working shapes 11 in FIG. 17 are rounded as if they were replaced by the convex working shapes 21.

With a shaped article having the fine shape of the convex working shapes 21, an expansion of the angular field of view greater than that (approximately 40 degrees) of the shaped article having the fine shape of the triangular working shape 11 according to the first working mode is observed in comparison with an alternative shaped article which has no fine shape. In the shaped article, the working shape does not have a linear line. Particularly, since the top portion of the working shape is not an apex of a triangular shape but is an elliptic arc, it is considered that the reflection direction does not become fixed and the angular field of view is expanded significantly.

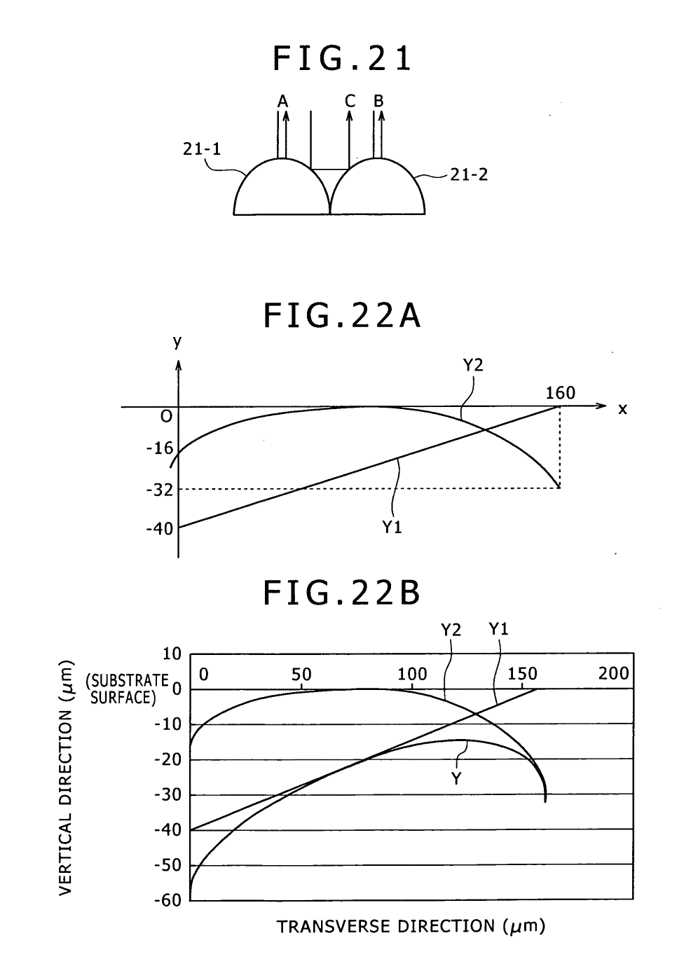

Furthermore, in the shaped article having a fine shape according to the present mode, depth in color is observed due to a rearward reflection effect. FIG. 21 illustrates a rearward reflection effect of the very fine uneven surface structure formed from the convex working shape 21 shown in FIG. 20. In the example of FIG. 21, two convex working shapes 21-1 and 21-2 are provided, and laser beams A and B incident to top portions of the convex working shapes 21-1 and 21-2 are reflected in the opposite directions to the respective incidence directions. Further, the laser beam C incident to an inclined portion at which a tangential line to the curved face of the convex working shape 21-1 is inclined is reflected toward the curved face of the other adjacent convex working shape 21-2. Then, the laser beam C reflected toward the curved face of the convex working shape 21-2 is reflected by an oblique portion of the curved face of the convex working shape 21-2 so that it advances in parallel and in the opposite direction to the incidence direction of the convex working shape 21-2. Consequently, the laser beam C interferes with the laser beam B reflected by the top portion of the convex working shape 21-2. By such interference of the laser beams, depth in color increases in comparison with that in the case of a shaped article having no fine shape, which reflects light only by regular reflection.

In the present working mode, if the curved face at the top portion of the working shape is different from such a linear line as in the case of the triangular working shape 11 but exhibits some other curved line such as a semicircle, then an effect similar to that obtained by the convex working shape 21 having an elliptic arc can be achieved. Visual evaluation is hereinafter described in detail together with other fine working shapes.

It is to be noted that, also in the present mode, various materials which absorb a laser wavelength can be applied as a material for the substrate S similarly as in the first working mode. Further, in place of direct working of a fine shape, also a method may possibly be used wherein a metal mold is fabricated using a shaped part as an original to transfer the shape or a film is produced and pasted.

### <4. Third Working Mode>

A third working mode is an example wherein the mask having a straight line on an edge of the opening m1 shown in FIG. 15A and the mask having an elliptic arc on an edge of an opening m1 shown in FIG. 19A are used to apply a fine shape like a curved face on the substrate surface.

From the expressions (1) and (2) given hereinabove, when 0<X<80, the approximation expression Y2 is given as an expression (3), but when 80<X<160, the approximation expression Y2 is given as an expression (4). Then, the actual etching amount is given by an expression (5).

Y2={1/5 √(6400−(X−80)²)−16 (3)

Y2={2/5 √(6400−(X−80)²)−32 (4)

Y=Y1+Y2 (5)

Therefore, if the mask M(1) having a linear line shown in FIG. 15A and the mask M(2) having an elliptic arc shown in FIG. 19A are used and placed one on the other and a laser beam is irradiated upon the masks M(1) and M(2), then such a synthesized profile as shown in FIGS. 22A and 22B is obtained as a working shape.

FIG. 22A illustrates the approximation expression Y1 corresponding to an expression (6) and the approximation expression Y2 corresponding to mathematically approximated expressions (3) and (4). Meanwhile, FIG. 22B illustrates an actually obtained shape and indicates the approximation expressions Y1 and Y2 and an etching amount Y obtained when a laser beam is irradiated upon the masks M(1) and M(2) placed one on the other.

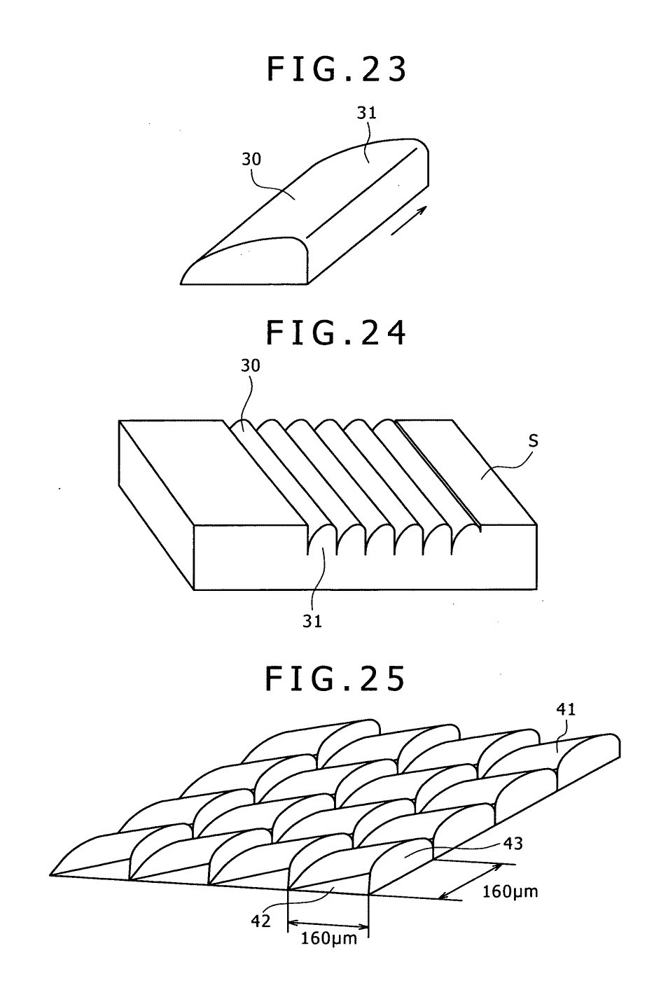

If such design as illustrated in FIG. 22B is carried out, then such a convex working shape 31 which has an asymmetric cross section and has a curved face 30 as shown in FIG. 23 is formed. The convex working shape 31 is shaped such that the triangular working shape 11 is rounded at apexes thereof.

FIG. 24 shows a three-dimensional shape formed based on the design of FIG. 22B. The shaped article shown in FIG. 24 has a fine shape wherein a plurality of pole-like shapes each having a cross sectional shape of the convex working shape 31 are formed in a juxtaposed relationship in a direction perpendicular to the scanning direction, that is, in the x axis direction, and have a plurality of mountains having a curved top portion.

With regard to this shaped article having the fine shape of the convex working shape 31, it has been confirmed successfully that the reflection angle is increased by the application of the curved face 30 and the reflection angular field of view is greater by 20 degrees than that of the fine shape having the triangular working shape 11 in the first mode. Visual evaluation is hereinafter described in detail together with other fine working shapes.

In this manner, it is possible to apply a factor of the convex working shape 21 or cylindrical shape having a curved face on the triangular working shape 11, which is a shape of a triangular pole, by using the mask having a linear line on an edge of an opening m1 shown in FIG. 15A and then using the mask having an elliptic arc on an edge of an opening m1 shown in FIG. 19A. In other words, according to the laser working technique of the present mode, working of a composite shape formed from a combination of a plurality of shapes can be carried out, and a free fine shape which takes an optical characteristic into consideration can be formed on the working face of the substrate S.

It is to be noted that, also in the present mode, various materials which absorb a laser wavelength can be applied as a material for the substrate S similarly as in the first and second working modes. Further, in place of direct working of a fine shape, also a method may possibly be used wherein a metal mold is fabricated using a shaped article as an original to transfer the shape or a film is produced and pasted.

With the mask configurations according to the first to third working modes described above, the time for setting and the cost for production of a mask can be reduced even if the mask is for obtaining a working shape of a complicated profile. Further, even with a mask provided by a small number of functions (multi-dimensional monomials), a working shape of a profile corresponding to various functions (multi-dimensional polynomials) can be obtained depending upon a combination.

Further, by managing the aspect ratio of a mask pattern and the aspect ratio of a working shape using a multiple, transfer from a two-dimensional mask to a three-dimensional working shape can be carried out without being influenced by the numerical aperture and so forth of the mask.

Further, since there is no necessity to design a curve of a multi-dimensional polynomial by CAD (Computer Aided Design), software for conversion is not required. Further, also an error upon conversion can be prevented.

Furthermore, by applying a three-dimensional fine working shape to an armor or housing using a laser, the armor or housing of high quality having high durability can be provided.

### <5. Fourth Working Mode>

A fourth working mode is an example wherein a free fine surface shape having a curved face can be produced by laser working and particularly a composite roof tile shape imitating a roof tile structure which is found in a wing of a butterfly or a moth is produced.

FIG. 25 shows an example of a composite roof tile shape imitating a roof tile structure. Referring to FIG. 25, a working shape 41 which is one of mountains of a fine structure formed on a substrate S has, as viewed from one direction, a planar shape of a triangular working shape 42 but has, as viewed in a perpendicular direction, a curved face shape of a convex working shape 43. This curved face shape can be produced readily only by changing, if the OG method described hereinabove is used, a mask and changing the scanning direction to a perpendicular direction. For example, the curved face shape can be formed by using the mask having a linear line on an edge of an opening m1 shown in FIG. 15A and the mask having an elliptic arc on an edge of an opening m1 shown in FIG. 19A such that the scanning directions of them are perpendicular to each other. The width of the triangular working shape 42 side is 160 μm and the width of the convex working shape 43 side is 160 μm.

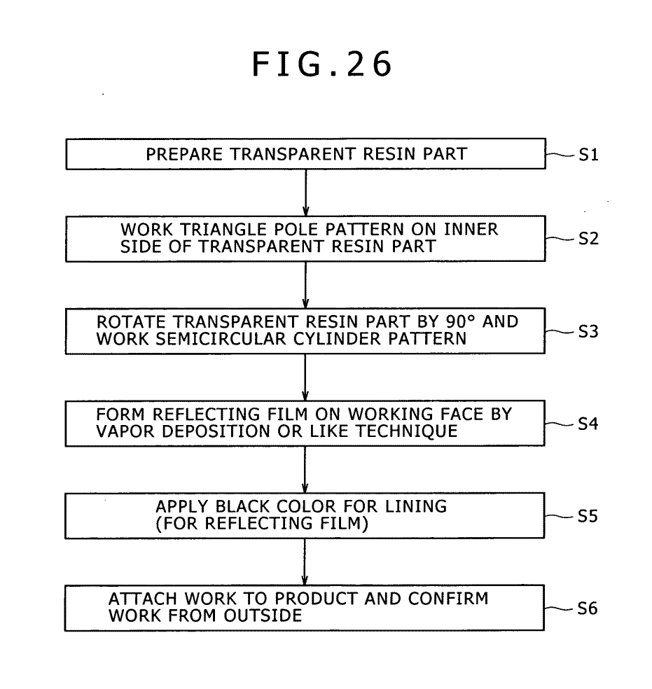

In the following, a manufacturing method of a product having the fine surface shape shown in FIG. 25 is described with reference to a flow chart shown in FIG. 26.

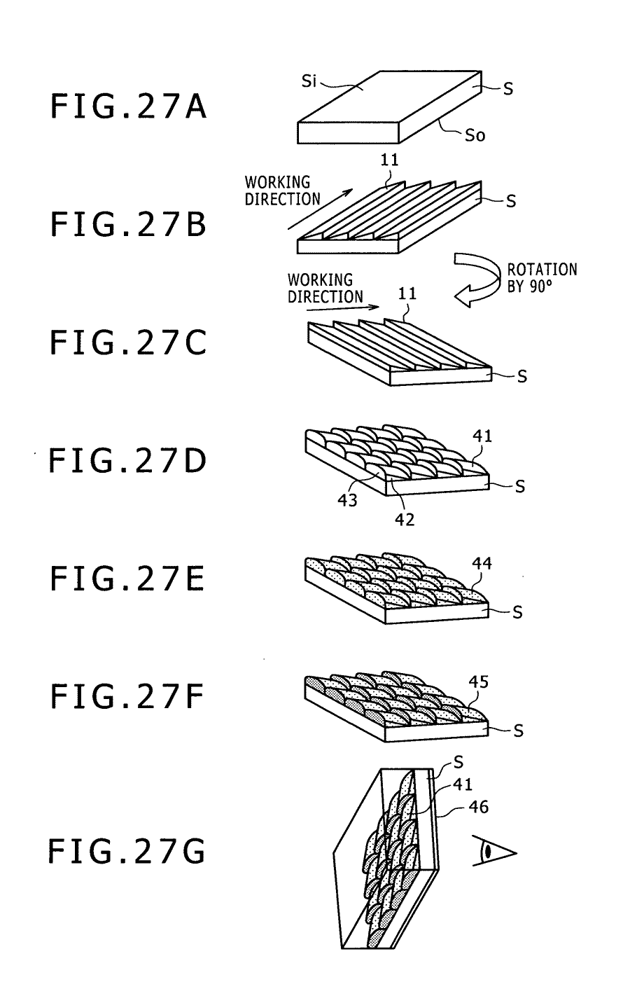

First, a substrate S which is a transparent resin part is prepared and is placed on the stage 7 such that the substrate inner side Si (FIG. 27A) thereof becomes a working face at step S1. Then, the mask having a linear line on an edge of an opening m1 of FIG. 15A is used to carry out laser working to form triangular working shapes 11 (FIG. 27B: triangular pole patterns) on the substrate inner side Si at step S2.

Then, the stage 7 is used to rotate the substrate S by 90 degrees with respect to the scanning direction and the mask having an elliptic arc on an edge of an opening m1 shown in FIG. 19A is used to carry out laser working to form convex working shapes 21 (FIG. 27C: semi-cylindrical patterns) on the substrate inner side Si at step S3. After this process comes to an end, the substrate S has working shapes 41 (FIG. 27D) formed thereon which have a planar shape of triangular working shapes 42 as viewed in one direction and a convex working shape 43 as viewed from a perpendicular direction.

Then, a reflecting film 44 (FIG. 27E) is formed on the working face, on which a large number of such working shapes 41 are formed, by a technique such as vapor deposition at step S4. Further, a color film 45 (FIG. 27F) of black for lining is applied in order to assist the reflection action of the reflecting film 44 at step S5.

Then, the substrate S is attached to a product such that the working face side of the substrate S having the triangular working shapes 11 is opposed to the product. Then, a protective film 46 is formed on the outer side of the substrate S, that is, on the opposite side to the working face, (FIG. 27G) and a visual effect is confirmed from the outer side at step S6. It is to be noted that, since the protective film 46 is not provided on the working face side on which the working shapes 41 are formed, it may be determined arbitrarily whether or not the protective film 46 should be formed.

From the fine shape (FIG. 25) formed in this manner, depth in color is observed due to a rearward reflection effect. Since the fine shape by the present mode is complicated in shape of a curved face in comparison with the fine shapes by the first to third modes, it causes complicated interference and provides more significant depth in color. Therefore, an armor or housing having a visual effect which has not been achieved as yet can be provided. For example, it is possible to create complicated gradations in color such as to expand a reflection region of light.

### <6. Very Fine Uneven Structure>

An example of a working mode having a very fine uneven structure intentionally produces a working mark unique to fine working using a laser. The working mark here signifies marks of intermittent working by mask edges formed when a laser beam is irradiated upon a working face through a mask while the mask or the stage is finely fed for each one shot to move the laser irradiation region with respect to the working face. Further, a pattern formed from the working mark is particularly called also shell mark.

In the example described below, particularly an excimer laser and a mask are used to apply working marks of the order of the several hundreds nanometer in the depthwise direction on the working face to form very fine uneven shapes. With a depth of the several tens nanometer order, it is considered that a human being can recognize an effect of diffraction, and besides, since the size is smaller than a wavelength level at a diffraction limit, the diffusion effect is extremely low. Upon movement of the substrate, the shape of a boundary line, that is, a mask edge, between an opening and a blocking portion of the mask, is transferred as a large number of irradiation marks on the working face.

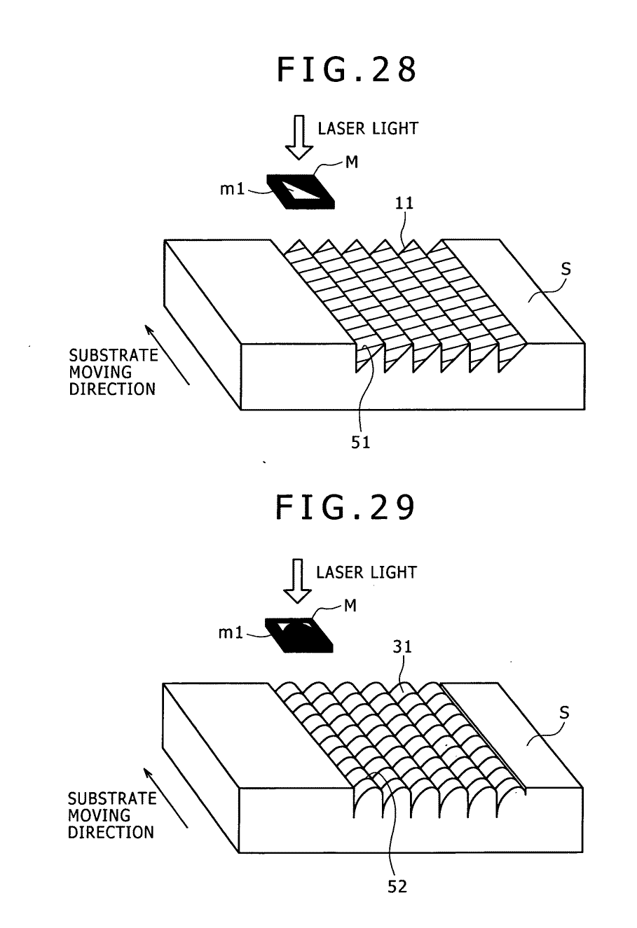

FIG. 28 illustrates an example wherein the mask having a linear line on an edge of an opening m1 shown in FIG. 15A is used to produce working marks. Since a triangular mask pattern is used, a plurality of linear working marks 51 are applied particularly to the slanting face 10 of a triangular working shape 11 as seen in FIG. 28.

Two methods are available for producing such working marks 51. A first one of the methods forms working marks 51 simultaneously with formation of triangular working shapes 11 by laser working. A second one of the method scans, after triangular working shapes 11 are formed, the same place again to produce working marks 51 on the triangular working shapes 11. In this instance, since, after the triangular working shapes 11 are formed, a laser beam is irradiated again on the same place, a greater number of working marks are formed on the working face, resulting in enhancement of the diffusion effect. Further, the energy density of the laser beam to be irradiated upon the substrate S is adjusted by the control section 8 so that it falls within a range within which the shape of the triangular working shape 11 is not deformed significantly while working marks of an appropriate depth are produced.

The working mark 51 can be controlled freely in terms of the etching depth and width, shape and so forth by suitably designing the mask opening shape, energy density, stage feeding speed, focusing position and so forth. A method of freely controlling the etching depth and width, shape and so forth of working marks is hereinafter described. It is to be noted that, in FIG. 28, working marks are shown with a greater pitch than an actual pitch for the convenience of illustration.

### Working Marks of Convex Working Shape by Excimer Laser

FIG. 29 illustrates production of working marks 52 using the mask having a linear line on an edge of an opening m1 shown in FIG. 15A and the mask having an elliptic arc on an edge of an opening m1 shown in FIG. 19A and placing the masks one on the other. In this instance, working marks which rely upon the opening of the masks used for later irradiation remain. FIG. 29 illustrates an example when the mask of FIG. 15A and the mask of FIG. 19A are placed one on the other in this order. A slanting line formed by an opening m1 shown in FIG. 15A, that is, a working mark 51 of FIG. 28, is canceled, but a shape which relies upon an opening m1 shown in FIG. 19A remains. Although the mask M shown in FIG. 19A has an elliptic arc and a linear line on an edge of the opening m1, in the case of the mask M shown in FIG. 29, a linear line shape which corresponds to the shape of the mask M at the trailing end in the relative advancing direction of the mask M is applied as a working mark 52. If the mask M is rotated by 180 degrees and the elliptic shape becomes a shape at the trailing end in the relative advancing direction, then the working mark 52 now exhibits a substantially semicircular curved line shape as viewed in the laser irradiation direction.

### Working Mark by Solid-State Laser

In the following description of a working mode, a working mark in the case where a solid-state laser of a type which has a small beam diameter and directly draws without using a mask is described. Since the beam diameter of a solid-state laser is approximately φ10 to 50 μm, working marks synchronized with the beam diameter, that is, having a shape corresponding to the beam diameter, are applied to the working face.

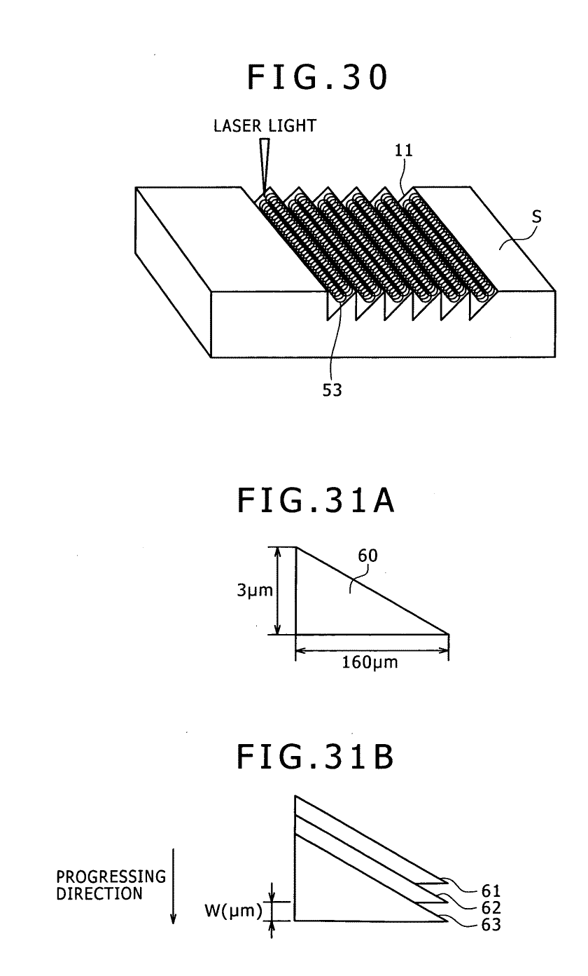

FIG. 30 illustrates working marks in the case where a solid-state laser is used. In the case where a solid-state laser is used, a working mark 53 is shaped such that round shapes of the beam diameter are superposed in the scanning direction. For example, in the case where a solid-state laser of the fourth harmonic (266 nm) is used, since the beam diameter generally is φ10 to 50 μm, working marks of the depth of the order of several hundreds nanometer by a beam edge are applied to the working surface.

A very fine uneven structure which makes use of such working marks or shell marks is, in the case where the etching depth is several tens nm, poor in effect of decoration because the diffraction size is smaller than the wavelength level. However, in the case where the etching depth is on the submicron order of several hundreds nm, an effect appears with the very fine uneven structure. In other words, if the depth of working marks is on the wavelength level, then a diffusion effect is provided by the working marks and a visual effect or structure color effect of increase in luster and depth of a color appears. Further, incoherence is generated by the diffusion effect of working marks and the reflection angular field of view expands. It has been obtained by an experiment that this visual effect of the very fine uneven structure is not exhibited or the visual effect is poor in the case where the etching depth is on the several tens nm level.

In the following, formation of a very fine uneven structure which utilizes working marks is described in more detail.

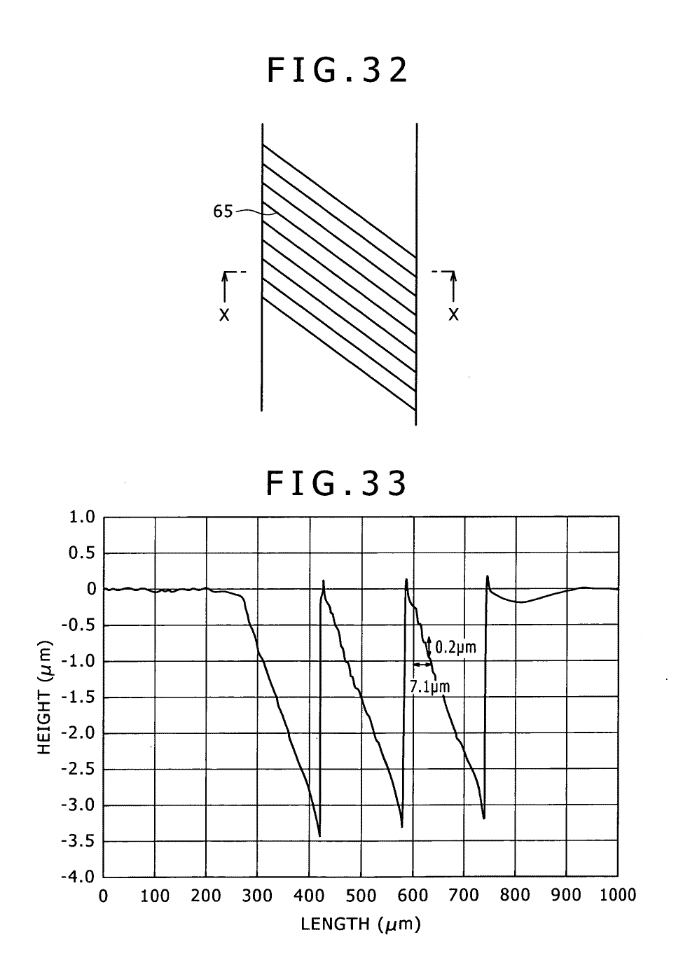

FIGS. 31A and 31B illustrate formation of a very fine structure making use of working marks, and particularly FIG. 31A is a sectional view of a first working mode of a triangular working shape and FIG. 31B is a top plan view illustrating superposition of mask patterns, that is, laser irradiation regions. FIG. 32 is a top plan view showing a continuous pattern of working marks. It is to be noted that a line X-X shown in FIG. 32 indicates a direction along which a cross section of the first working mode of FIG. 31A is to be taken.

The example of a cross sectional shape 60 shown in sectional view of FIG. 31A is a triangular working shape (which corresponds to the first working mode) having a width of approximately 160 μm and a height of approximately 3 μm. In order to form the cross sectional shape 60 of the height of 3 μm, it is necessary to etch the working face before working by 3 μm from its surface. However, the etching amount or etching rate per one shot of a laser beam depends upon the energy density of the laser beam to be irradiated if the material of the substrate as a working object is the same. For example, with a resin material used in the present mode, the following data have been obtained.

| Energy density | |
|---|---|
| (mJ/cm²) | Etching rate (nm/shot) |
| (a) 100 | approximately 46 |
| (b) 200 | approximately 93 |
| (c) 300 | approximately 142 |

In order to obtain a fine shape of 3 μm high, the movement amount between the mask and the substrate is controlled such that, while the laser irradiation region is successively moved by W μm in the advancing direction, a laser beam is irradiated by a plural number of times on the working face as indicated by laser irradiation regions 61, 62 and 63 such that the mask patterns or laser irradiation regions may partly overlap with each other as seen in a top view of FIG. 31B. Thereupon, working marks of the W μm pitch are formed successively as seen in FIG. 32. In the case of the data for the height of approximately 3 μm described above, when the energy density is 100 mJ/cm², 64 shots are required; when the energy density is 200 mJ/cm², 32 shots are required; and when the energy density is 300 mJ/cm², 21 shots are required. Since the visual effect by the very fine shape formed by an edge of an opening of a mask is exhibited strongly when the etching depth is on the 100 nm order, preferably the depth of the very fine shape is approximately 142 nm of (c) from among the energy densities of (a) to (c) given above. Therefore, if a laser of the energy density 300 mJ/cm² of (c) is used to carry out fine working, then a very fine shape from which a visual effect can be obtained can be produced. In the case of (a) with which the same fine shape can be obtained, the depth of the very fine shape obtained upon fine shape formation is so small that a diffusion effect which has an influence on the visual sense cannot be obtained.

It is to be noted that, in the case where the laser of the energy density 200 mJ/cm² of (b) is used to carry out fine working, a sufficient visual effect can sometimes be obtained.

Here, the distance between or pitch of adjacent working marks is adjusted by controlling the speed of movement of the laser irradiation region on the working face, that is, the relative feeding speed of the mask with respect to the substrate placed on the stage, and the frequency of the laser irradiation. For example, in order to increase the pitch, either the speed of movement of the laser irradiation region is raised or the frequency of the laser irradiation is lowered, or else both of the controls are used. On the contrary, in order to reduce the pitch, either the speed of movement of the laser irradiation region is lowered or the frequency of the laser irradiation is raised, or else both of the controls are used.

In this manner, the etching rate of a very fine working shape depends upon the material of the working object article, the wavelength of the laser beam and the energy density of the laser beam. On the other hand, the opening shape of the mask and the energy density depend upon the required shape, that is, upon the fine shape to be formed. By selecting an optimum energy density paying attention to the depthwise direction of the very fine shape from among available energy densities, a visual effect by the very fine shape, that is, a structure color effect, can be obtained. Conversely speaking, a visual effect which can be used for decoration cannot be obtained if synthetic condition setting with attention paid to a very fine structure is not carried out following the procedure described above upon laser working.

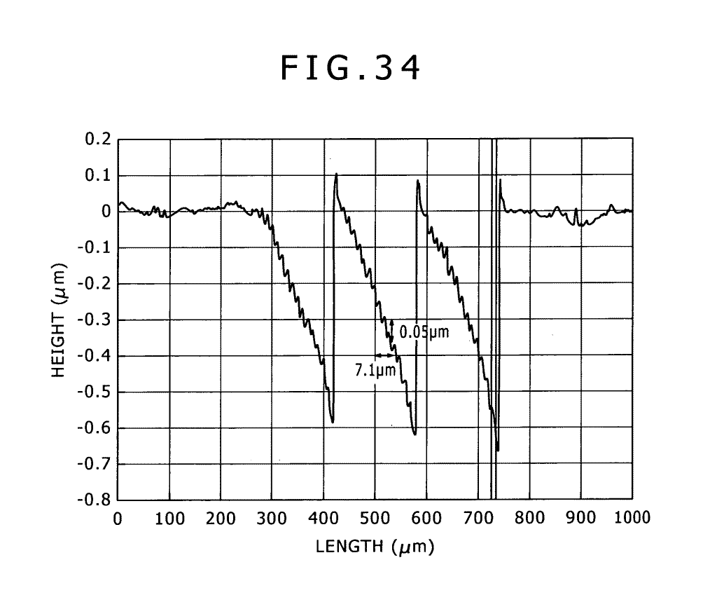

FIG. 33 illustrates an example of measurement of a sectional shape of working marks in the case where a visual effect by a very fine shape, that is, a structure color effect, is obtained strongly. Meanwhile, FIG. 34 illustrates an example of measurement of a sectional shape of working marks in the case where the structure color effect is poor. Both of FIGS. 33 and 34 illustrate measurement in the case of the first working mode, that is, in the case where the sectional shape is a triangular working shape.

In the case of FIG. 33, the triangular working shape has a width of approximately 160 μm and a height of approximately 3 μm, and the working marks of a very fine shape on an inclined face portion have a pitch of approximately 7.1 μm and a depth of 0.2 μm. In the case where the very fine shape depth is on the order of several hundreds nm in this manner, a strong structure color effect can be obtained.

In contrast, in the case of FIG. 34, the triangular working shape has a width of approximately 160 μm and a height of approximately 0.6 μm, and the working marks of a very fine shape on an inclined face portion have a pitch of approximately 7.1 μm and a depth of 0.05 μm. In the case where the very fine shape depth is on the order of several tens nm in this manner, the structure color effect is poor.

### Pattern of Working Marks Formed on Working Face

It is to be noted that the working mark described above varies depending upon the direction of movement of the laser irradiation region on the working face, and consequently, also the structure color effect when the working face is viewed in the same direction differs. In the following, the pattern or direction of working marks formed on a working face is described.

At an overlapping portion between different laser irradiation regions, a laser beam is irradiated again upon a region upon which the laser beam is irradiated formerly, and a working mark in the preceding laser irradiation region disappears or becomes sparse. In other words, at a place at which different laser irradiation regions overlap with each other, a working mark formed by the laser irradiation region which is later in order of the laser beam irradiation is dominant. This fact can be utilized to control a pattern of working marks produced by laser irradiation.

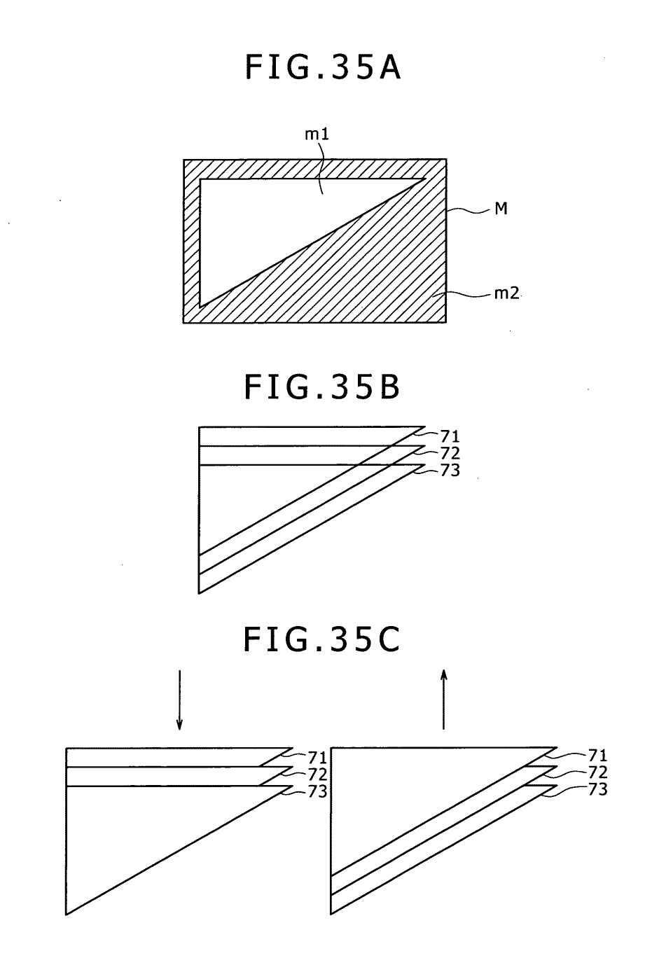

FIGS. 35A to 35C show working marks formed where a mask having a triangular opening is used.

A mask M shown in FIG. 35A which has an opening m1 of a right-angled triangle and a light blocking portion m2 is used to successively move the laser irradiation region in a perpendicular direction to one side of the right-angled triangle which is not the hypotenuse to positions represented as laser irradiation regions 71, 72 and 73 as seen in FIG. 35B. In this instance, if the laser irradiation region is successively moved such that the laser irradiation regions 71, 72 and 73 overlap with each other at the hypotenuse of the right-angled triangle thereof as indicated by an arrow mark in the figure on the left side in FIG. 35C, then working marks formed by the side of the right-angle triangle which is perpendicular to the moving direction are dominant. On the other hand, if the laser irradiation region is successively moved such that the laser irradiation regions 71, 72 and 73 do not overlap with each other at the hypotenuse of the right-angled triangle thereof as indicated by an arrow mark in the figure on the right side in FIG. 35C, then working marks formed by the hypotenuse of the right-angle triangle are dominant.

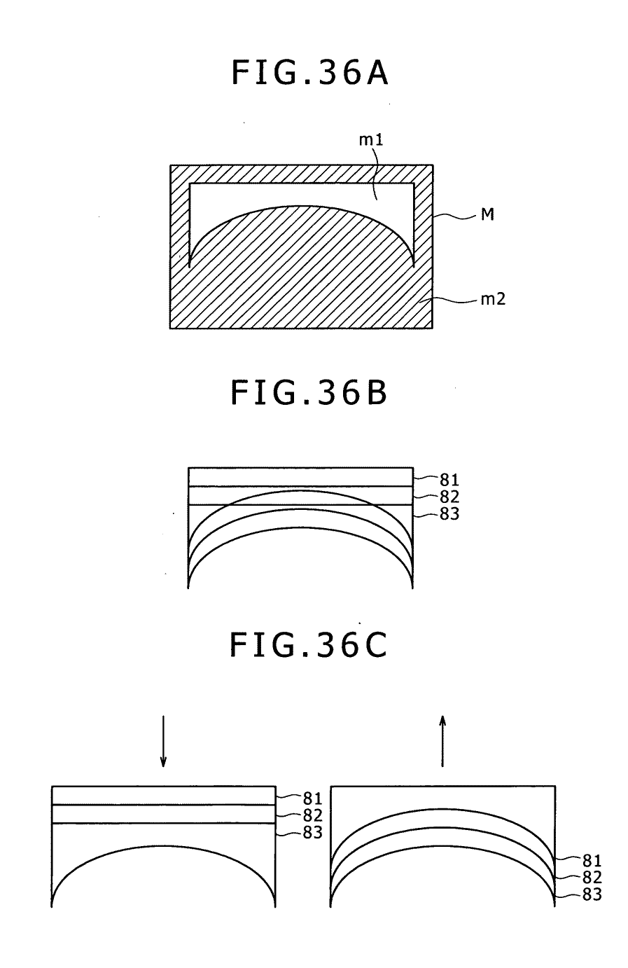

FIGS. 36A to 36C show working marks formed where a mask having an opening including a concave curved face is used.

A mask M shown in FIG. 36A which has an opening m1 including a concave curved face and a light blocking portion m2 is used to successively move the laser irradiation region in a perpendicular direction to one side of the opening which is opposed to the concave curved face to positions represented as laser irradiation regions 81, 82 and 83 as seen in FIG. 36B. In this instance, if the laser irradiation region is successively moved such that the laser irradiation regions 81, 82 and 83 overlap with each other at the concave curved face of the opening thereof as indicated by an arrow mark in the figure on the left side in FIG. 36C, then working marks formed by the side of the opening which is perpendicular to the moving direction are dominant. On the other hand, if the laser irradiation region is successively moved such that the laser irradiation regions 81, 82 and 83 do not overlap with each other at the concave curved face of the opening thereof as indicated by an arrow mark in the figure on the right side in FIG. 36C, then working marks formed by the concave curved face are dominant.

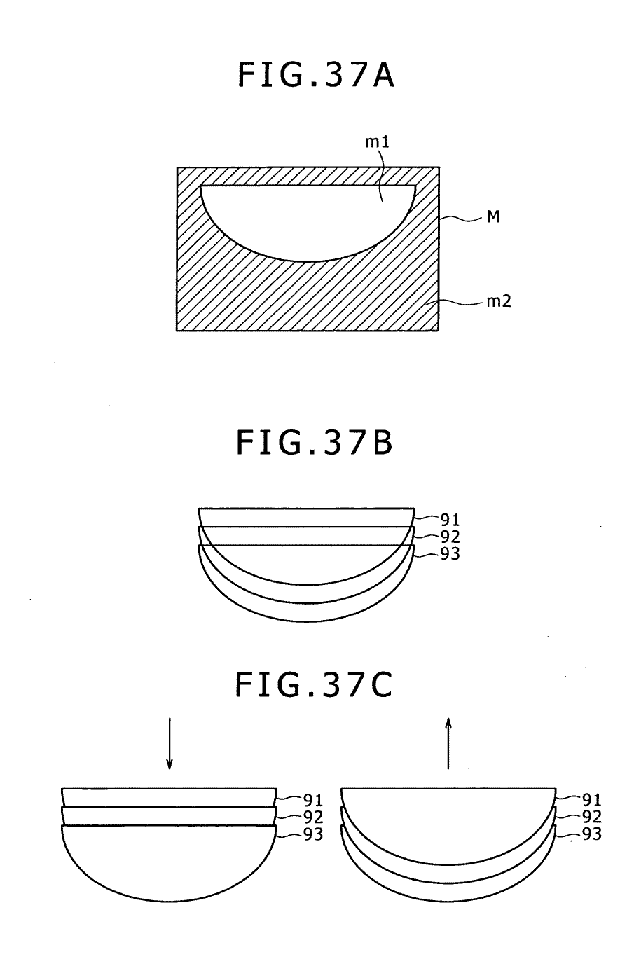

FIGS. 37A to 37C show working marks formed where a mask having an opening including a convex curved face is used.

A mask M shown in FIG. 37A which has an opening m1 including a convex curved face and a light blocking portion m2 is used to successively move the laser irradiation region in a perpendicular direction to one side of the opening which is opposed to the convex curved face to positions represented as laser irradiation regions 91, 92 and 93 as seen in FIG. 37B. In this instance, if the laser irradiation region is successively moved such that the laser irradiation regions 91, 92 and 93 overlap with each other at the convex curved face of the opening thereof as indicated by an arrow mark in the figure on the left side in FIG. 37C, then working marks formed by the side of the opening which is perpendicular to the moving direction are dominant. On the other hand, if the laser irradiation region is successively moved such that the laser irradiation regions 91, 92 and 93 do not overlap with each other at the convex curved face of the opening thereof as indicated by an arrow mark in the figure on the right side in FIG. 37C, then working marks formed by the convex curved face are dominant.

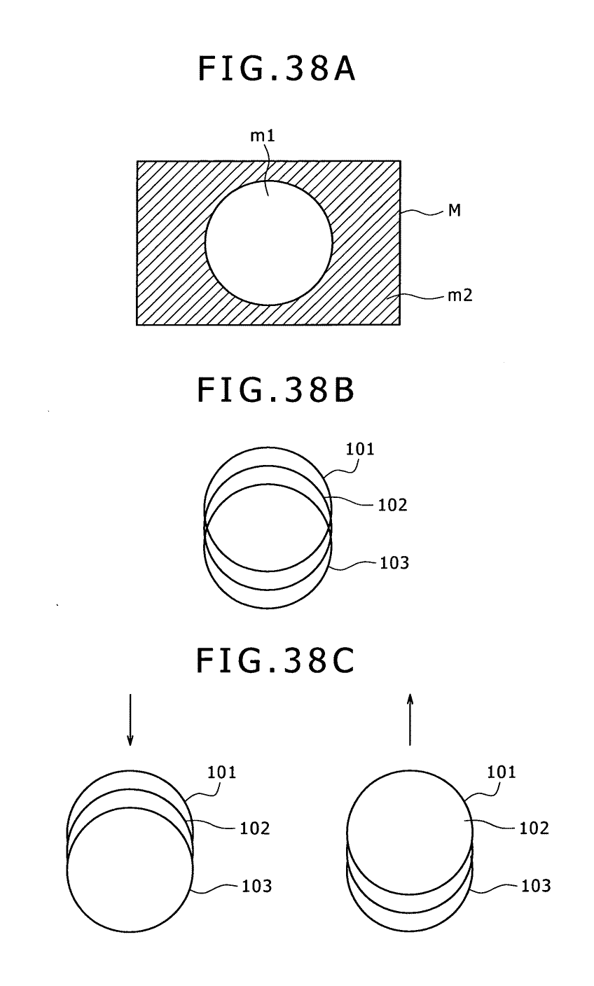

FIGS. 38A to 38C show working marks formed where a mask having a circular opening is used.

A mask M shown in FIG. 38A which has a circular opening m1 and a light blocking portion m2 is used to successively move the laser irradiation region in a perpendicular direction along a linear line which passes the center of a circle to positions represented as laser irradiation regions 101, 102 and 103 as seen in FIG. 38B. In this instance, if the laser irradiation region is successively moved such that the laser irradiation regions 101, 102 and 103 overlap with each other at an arc on the lower side in FIG. 38B of the circle as indicated by an arrow mark in the figure on the left side in FIG. 38C, then working marks formed by an arc of the circle on the trailing end side in the moving direction, that is, by an arc of the circle on the upper side in FIG. 38C, are dominant. On the other hand, if the laser irradiation region is successively moved such that the laser irradiation regions 101, 102 and 103 overlap with each other at an arc on the upper side in FIG. 38B of the circle thereof as indicated by an arrow mark in the figure on the right side in FIG. 38C, then working marks formed by an arc of the circle on the trailing end side in the moving direction, that is, by an arc of the circle on the lower side in FIG. 38C, are dominant.

Since the pattern of very fine shape of working marks to be formed on a working face can be controlled by the opening shape of the mask and the direction of movement of the laser irradiation region, a variation can be provided to an effect of appealing the visual sense of a user. For example, even if the fine shape is same, if the pattern of working marks is changed in response to the face of an armor or housing to be shown to the user, then it is possible to provide a variation in the structure color effect for each face of the same product.

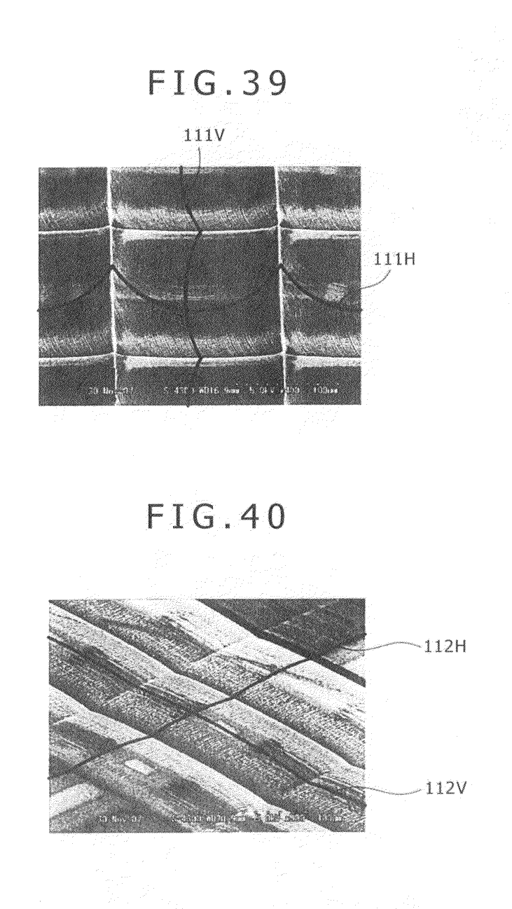

FIGS. 39 and 40 show particular examples of working marks or shell marks. The example of FIG. 39 shows an example of circular working marks having a large curved face, and in order to facilitate understandings, one working mark 111V extending in the vertical direction and one working mark 111H extending in the horizontal direction are represented in an emphasized state. Meanwhile, the example of FIG. 40 shows an example of line-shaped working marks, and one working mark 112V extending in the vertical direction and one working mark 112H extending in the horizontal direction are represented in an emphasized state.

It can be recognized from the states of the working marks that, in the example of FIG. 39, the working mark 111V was formed after the working mark 111H. On the other hand, it can be recognized that, in the example of FIG. 40, the working mark 112H was formed after the working mark 112V.

With the working marks in the working modes described above, an effect has been confirmed that, when the angle of shaped articles which have a very fine shape on which working marks are formed intentionally is changed, not only the reflection angle expands but also improved quality and color tone can be obtained over a wide angle similarly.

### <7. Visual Effect>

### Comparison by Plurality of Fine Shapes

Now, visual evaluation of shaped articles to which a fine shape is applied is described.

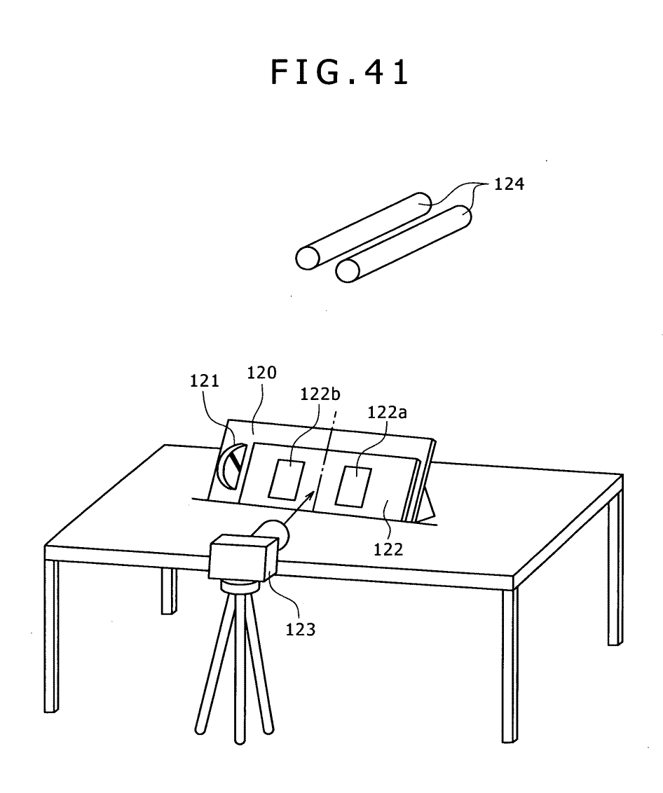

FIG. 41 illustrates a measuring method of visual evaluation data. Referring to FIG. 41, a sample 122 of an object of measurement is placed on a panel face 120 of an angle meter 121 placed on a desk. Then, light of a fluorescence lamp 124 is irradiated from above on the sample 122, and working faces 122a and 122b are imaged by a camera 123 while the angle of the working faces 122a and 122b with respect to the desk is successively changed. Then, the very fine shape formed on the working face is evaluated from the aspect of the visual sense.

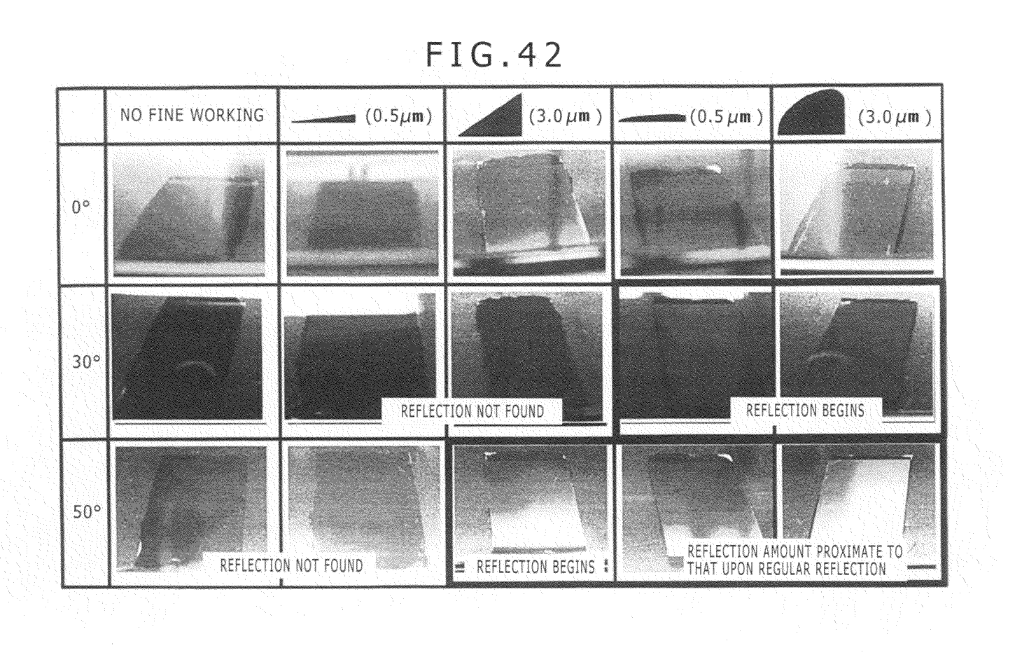

FIG. 42 illustrates a result of visual evaluation when various fine shapes are imaged by the camera 123 changing the angle of the samples.

The imaged samples include a sample having no fine shape worked thereon, another sample having a triangular working shape of 0.5 μm high according to the first working mode, a further sample having a triangular working shape of 3.0 μm high according to the first mode, a still further sample having a working shape of 0.5 μm high according to the third mode and a yet further sample having a work shape of 3.0 μm high according to the third working mode.

When the angle of a sample is 0 degrees, the sample is in a state in which it lies on the desk, and in this state, no example exhibits reflection. Then, when a sample is tilted up to 30 degrees, reflection begins with the working shape of 0.5 μm high according to the third working mode and the working shape of 3.0 μm high according to the third working mode. Further, when a sample is tilted up to 50 degrees, reflection begins with the triangular working shape of 3.0 μm high according to the first working mode. Meanwhile, the working shape of 0.5 μm high according to the third working mode and the working shape of 3.0 μm high according to the third working mode exhibit a reflection amount proximate to that in the case of regular reflection.

From the measurement described above, it is found that the reflection angular field of view of the working shape according to the third working mode is wider by 30 degrees than that of the working shape according to the first working mode. Further, it is found that only the sample of the first working mode wherein the etching depth is 0.5 μm exhibits degradation in terms of the view angle characteristic even in comparison with the sample of the same first working mode which, however, has the etching depth of 3.0 μm because the very fine shape is on the several tens nm order.

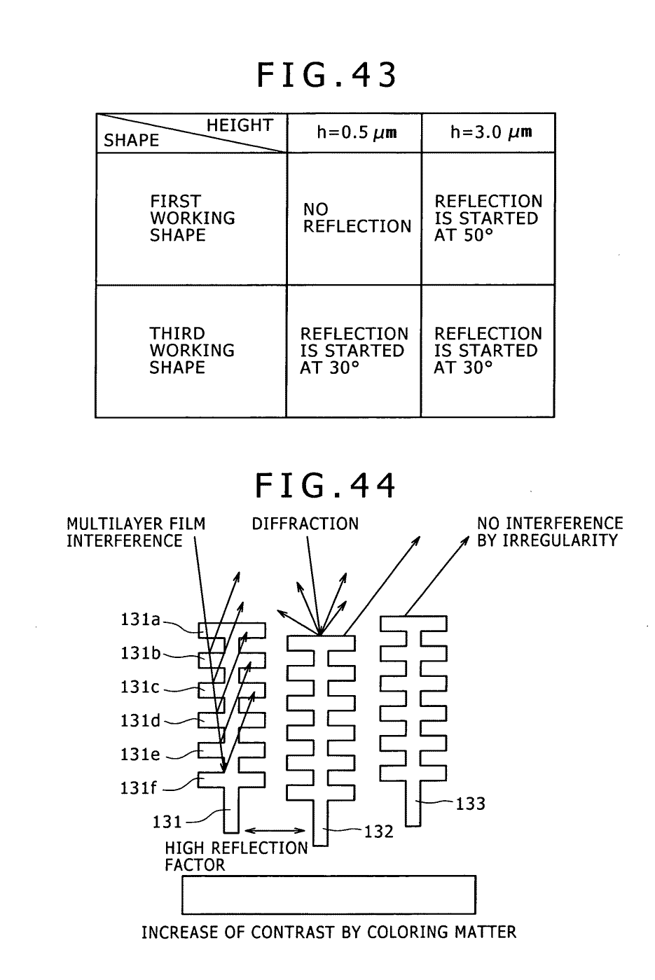

FIG. 43 is a table in which results of the visual evaluation of FIG. 42 are listed particularly with regard to the reflection stating angle and the reflection state. It is to be noted that h represents the etching depth.

As can be recognized from FIG. 43, in the case of the first working mode, no reflection occurs with the etching depth 0.5 μm, but in the case of the third working mode, where the etching depth is 0.5 μm, reflection is started at 30 degrees. Meanwhile, in the case of the first working mode, reflection is started at 50 degrees where the etching depth is 3.0 μm. In contrast, in the case of the third working mode, reflection is started at 30 degrees where the etching depth is 0.5 and 3.0 μm. In this manner, in the case of the third working mode, the reflection starting angle is small and a result of a good reflection state is obtained irrespective of the etching depth.

### Fine Structure of Surface of Wing of Butterfly

Here, a fine structure of the surface of a wing of a butterfly which exhibits similar effects to those of a fine shape and a very fine shape according to the present invention is described. A fine structure of the surface of a wing of a butterfly is described in the URL “http://mph.fbs.osaka-u.ac.jp/˜ssc/scvol1pdf/yoshioka.pdf.” FIG. 44 is a schematic view showing a fine structure of the surface of a wing of a Morpho butterfly. If the surface of a wing of the butterfly is watched through an electron microscope, then it has both of such a regular structure and an irregular structure as shown in FIG. 44. At a portion called lower layer scale, microstructures having approximately seven shelves 131a to 131f stand close together. Adjacent upper and lower ones of the shelves are spaced by a distance from each other such that the optical distance when light travels back and forth between the shelves corresponds to a wavelength of light of a particular color, for example, a blue color. Accordingly, reflected light from the shelves strengthens each other as in the case of multilayer film interference and the blue color is reflected strongly (regularity of the structure). Such multilayer interference on the surface of a wing of the butterfly as just described is implemented by reproducing such a structure as in the case of the lower layer scale 131 in FIG. 44 or by using, in actual products, a popular evaporated film for a working surface or an opposite face, and has no relation to the essence of the present invention.

On the other hand, leftwardly and rightwardly adjacent ones of the lower layer scales 131 to 133 exhibit a dispersion in height by a height of approximately one shelf. This randomness or irregularity in the heightwise direction signifies that light reflected from the adjacent shelf structures does not substantially make regular interference. The structure which causes noninterference by the irregularity corresponds to the fine shape in the present invention. Further, reflected light from the different shelf structures diffracts over a wide range of angle and acts like random reflection. The structure which causes such diffraction corresponds to the very fine shape or working mark. From those reasons, a wing of a Morpho butterfly looks blue from whichever angle it is viewed.

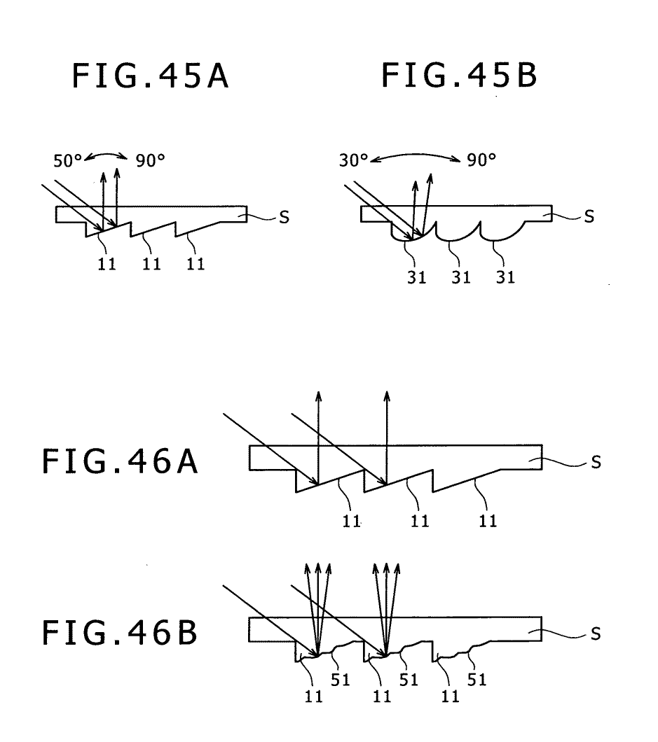

FIGS. 45A and 45B illustrate a study of visual evaluation depending upon presence or absence of a curved line shape. In particular, FIG. 45A shows a substrate which has the fine shape according to the first working mode and FIG. 45B shows another substrate S having the fine shape according to the third working mode. In the fine structure according to the first working mode, the reflection view angle is approximately 50 to 90 degrees because the working shape is a planar shape according to a linear line. On the other hand, in the fine structure according to the third working mode, the reflection view angle is approximately 30 to 90 degrees because the light interference area is expanded by a rounded portion of the working shape.

### Diffusion Effect

Now, a diffusion effect by the very fine shape which makes use of working marks is studied.

FIGS. 46A and 46B illustrate a study of visual evaluation depending upon the presence or absence of a working mark. In particular, FIG. 46A shows a substrate S which has the fine shape according to the first working mode and FIG. 46B shows another substrate S having the very fine shape by working marks. In the fine shape according to the first working mode, incident light is merely reflected by a linear line portion, that is, an inclined face, of a planar working shape. Meanwhile, in the case of the very fine shape wherein working marks 51 are formed, light is scattered by the working marks 51 formed on the portion which is originally a linear line portion or inclined face of the planar working shape. Consequently, since the light is diffused, depth is provided to the color. This corresponds to the diffraction by a wing of a butterfly illustrated in FIG. 44.

Now, a result of analysis of the reflection intensity of visible rays by the samples is described.

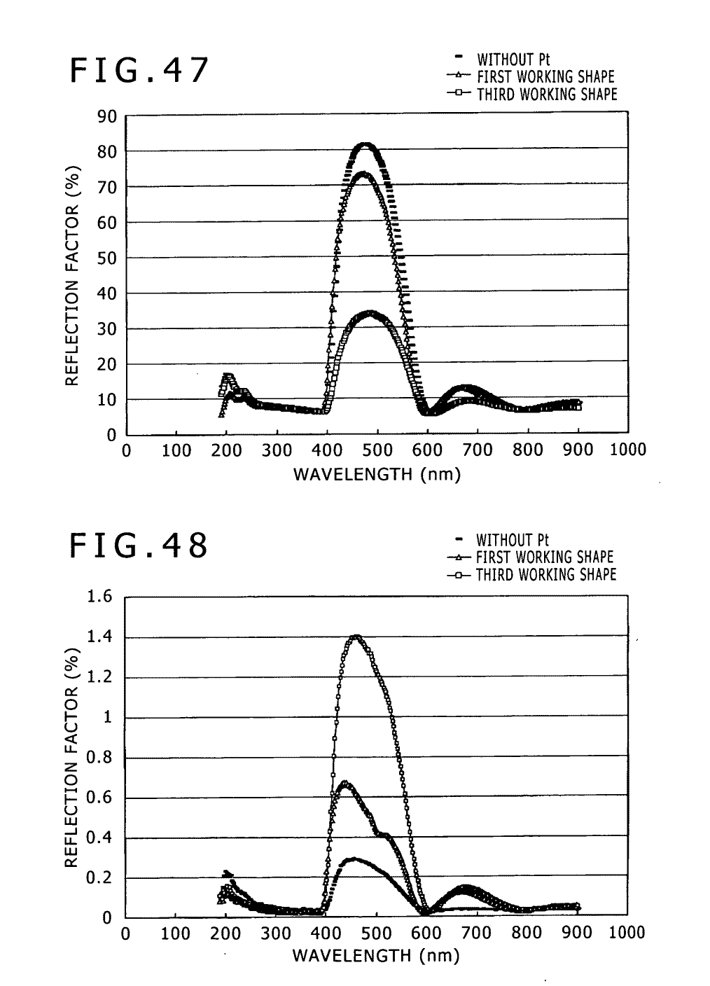

FIG. 47 illustrates a reflection intensity distribution regarding perpendicular visible rays (angle of reflection is 90 degrees). Meanwhile, FIG. 48 illustrates a reflection intensity distribution regarding visible rays where the molded articles are inclined by 5 degrees (angle of reflection is 85 degrees). As the measuring instrument, UV2400 by Shimadzu Corp. was used, and as the samples, a sample having no fine shape (no Pt) thereon, another sample having a fine structure of 0.5 μm deep according to the first working mode, and a further sample having a fine structure of 0.5 μm deep according to the third mode were used. Upon measurement, an Al mirror face which was one of supplies of the measuring instrument and has a reflection factor of 100% was used as a reference.

As seen in FIG. 47, with regard to perpendicular light, the sample having no fine shape exhibits the highest reflection factor while the samples having the fine shape according to the first working mode and the fine shape according to the third working mode exhibit rather low reflection factors. It is considered that the fact that the reflection factor is rather low represents increase of scattered light. On the other hand, if the samples are tilted even by a little amount such as approximately 5 degrees as shown in FIG. 48, then the reflection factor relationship reverses such that it decreases in the order of the sample having the fine shape according to the third working mode, the sample having the fine shape according to the first working mode and the sample having no fine shape. This indicates that a greater amount of scattered light is produced by the sample having the fine shape according to the third working mode and the fine shape according to the first working mode exhibit in this order. It is considered that this is an effect provided by noninterference by irregularity and diffraction.

### <8. Product Examples>

### Example Applied to an Electronic Apparatus

Now, examples of a product including a molded article having a very fine uneven surface structure according to one embodiment of the present invention are described.

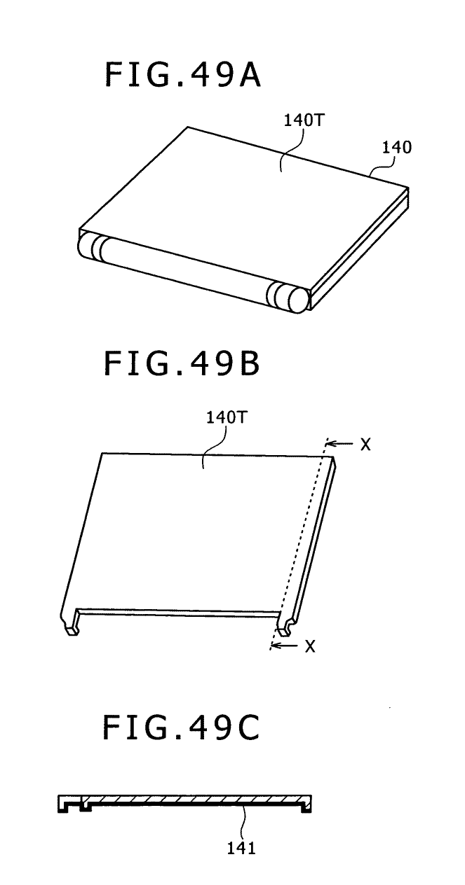

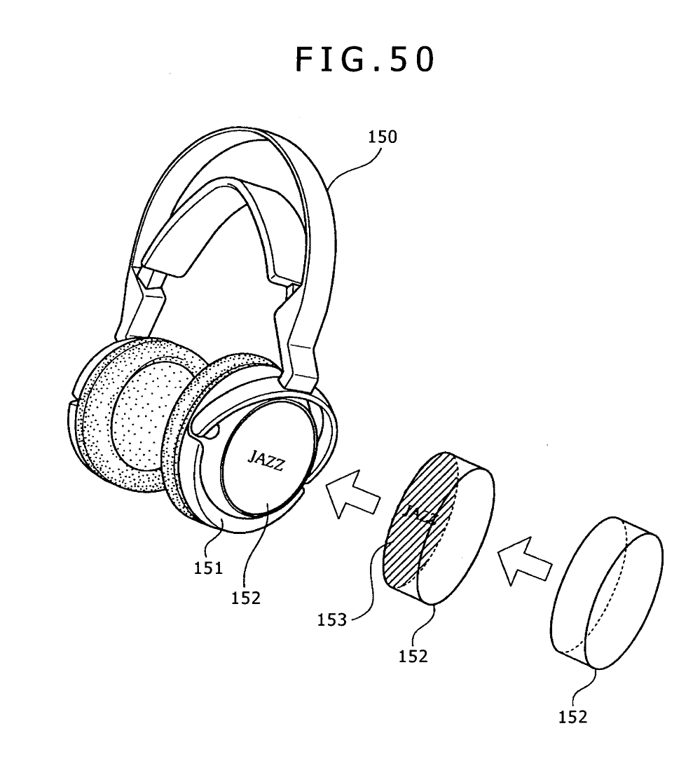

FIGS. 49A to 49C show a first product example in which a molded article having a very fine uneven surface structure is provided. As seen in FIG. 49A, a molded article having a very fine uneven surface structure according to the embodiment of the present invention is applied to a housing of such an electronic apparatus 140 in the form of a notebook type personal computer or the like. For example, FIG. 49C shows a cross sectional view taken along line X-X of a housing top lid 140T of the electronic apparatus 140 shown in FIG. 49B. In the present example, a three-dimensional fine shape is formed on the transparent armor inner side 141 of the housing top lid 140T.

### Example Applied to a Headphone

FIG. 50 shows a second product example wherein a molded article having a very fine uneven surface structure is provided. In the present example, a molded article having a very fine uneven surface structure is applied to a headphone unit 151 of a headphone 150. A rear face 153 of a transparent resin part 152 is formed by application of fine working and film formation, and the working face of the rear face 153 and a cover member of the headphone unit 151 are joined together.

According to the present invention configured in such a manner as in the embodiments thereof described hereinabove, since a laser working technique can create a free curved face shape, a complicated optical characteristic can be caused by a working surface. Therefore, it is possible to expand a reflection region of light or produce complicated gradations in color. Further, by a very fine shape which makes use of working marks or shell marks unique to laser working, the reflection angle can be enhanced, and not simple coloration by printing or the like but luster and depth of a color can be provided.

It is to be noted that, while, in the foregoing description of the preferred embodiments of the present invention, two masks are used to carry out fine working, naturally three or more masks may be used to carry out fine working.

It is to be noted that, in the present specification, the steps which are executed based on the program include not only processes which are executed in a time series in the order as described but also processes which may be but need not necessarily be processed in a time series but may be executed in parallel or individually without being processed in a time series. Further, the order of steps may be different from that described hereinabove.

The present application contains subject matter related to that disclosed in Japanese Priority Patent Application JP 2010-061391 filed in the Japan Patent Office on March 17, 2010, the entire content of which is hereby incorporated by reference.

It should be understood by those skilled in the art that various modifications, combinations, sub-combinations and alternations may occur depending on design requirements and other factors insofar as they are within the scope of the appended claims or the equivalent thereof.

What is claimed is:

1. A manufacturing method for a molded article having a very fine uneven surface structure wherein, while a laser irradiation region is successively moved with respect to a working face of a working object article for each one shot, a laser beam is repetitively irradiated upon the working face of the working object article, the manufacturing method comprising the steps of:
setting an energy density for the laser beam for carrying out working of the working face of the working object article to a predetermined depth;
setting a number of shots with which a desired fine shape is to be formed on the working face when the laser beam of the energy density is repetitively irradiated upon the working face;
calculating a speed of movement of the laser irradiation region with respect to the working face for irradiating the laser light of the set shot number upon the working face; and
irradiating the laser beam of the set energy density while the working face is moved relative to the laser irradiation region at the calculated speed of movement to form a very fine uneven structure formed from working marks by the laser light irradiation on the working face on which the fine shape is formed.

2. The manufacturing method for a molded article having a very fine uneven surface structure according to claim 1, wherein the working marks are formed based on a shape of an edge of an opening provided in a mask by which the laser irradiation region is determined.

3. The manufacturing method for a molded article having a very fine uneven surface structure according to claim 2, wherein a pattern of the working marks is controlled by a direction of movement of the laser irradiation region formed by the laser beam transmitted through the opening of the mask with respect to the working face.

4. The manufacturing method for a molded article having a very fine uneven surface structure according to claim 3, wherein first and second masks which have a plurality of openings juxtaposed in a widthwise direction thereof and having a same pitch but having different shapes therebetween are used such that, while the laser beam is irradiated upon the working object article through the first and second masks, the laser irradiation region of the laser beam is moved in a direction perpendicular to the widthwise direction, and the irradiation of the laser beam and the movement of the laser irradiation region are carried out for the working object article at the same position with the first and second masks.

5. The manufacturing method for a molded article having a very fine uneven surface structure according to claim 4, wherein the first and second masks are used such that the movement of the light irradiation region is carried out in two directions perpendicular to each other on the working object article.

6. The manufacturing method for a molded article having a very fine uneven surface structure according to claim 4, wherein the first and second masks are used such that the movement of the light irradiation region is carried out in the same direction on the working object article.

7. The manufacturing method for a molded article having a very fine uneven surface structure according to claim 4, wherein the etching depth of the working marks on the working face is several hundreds nanometer.

8. The manufacturing method for a molded article having a very fine uneven surface structure according to claim 1, wherein the working marks are formed based on a shape corresponding to a beam diameter of the laser beam to be irradiated.
